(19) United States
(12) Patent Application Publication
(10) Pub. No.: US 2026/0109385 A1
(43) Pub. Date: Apr. 23, 2026

(54) FOLDABLE CAR SEAT AND STROLLER COMBINATION SYSTEM

(71) Applicant: Graco Children's Products Inc., Atlanta, GA (US)

(72) Inventors: Jordi Dorca Pujol, Girona (ES); Matthew A. Johnson, South Haven, MI (US); Amanda Margaret Hadley, Wilmington, DE (US); Juan J. Jaume, Stone Mountain, GA (US); Balamurugan Rajavelu, Chennai (IN)

(73) Assignee: Graco Children's Products Inc., Atlanta, GA (US)

(21) Appl. No.: 19/346,802

(22) Filed: Oct. 1, 2025

Related U.S. Application Data
(60) Provisional application No. 63/709,124, filed on Oct. 18, 2024.
(60) Provisional application No. 63/756,736, filed on Feb. 10, 2025.

(51) Int. Cl. B62B 7/08; B60N 2/28; B62B 7/14; B62B 9/12; B62B 9/20

(52) U.S. Cl. CPC B62B 7/083; B60N 2/2845; B60N 2/2848; B60N 2/2893; B62B 7/145; B62B 9/12; B62B 9/203

(57) ABSTRACT

A car seat and stroller combination system includes a pair of front legs and a pair of back legs. The front legs and the back legs are designed such that they fold in an accordion-style configuration. In the unfolded state, the front legs are toward a front side of the car seat and stroller combination system and the back legs are toward a back side of the car seat and stroller combination system. However, in the folded state, the front legs are toward the back side of the car seat and stroller combination system and the back legs are toward the front side of the car seat and stroller combination system. The car seat and stroller system includes a handle than can be rotated in multiple positions and telescoped in or out by actuating a same button.

### CROSS-REFERENCE TO RELATED APPLICATIONS

This application claims the benefit of U.S. Provisional Patent Application No. 63/756,736 filed on Feb. 10, 2025, and U.S. Provisional Patent Application No. 63/709,124 filed on Oct. 18, 2024, each of which is incorporated in their entireties herein.

### TECHNICAL FIELD

The present disclosure relates generally to car seat systems. Specifically, the embodiments of the present disclosure are related to car seat and stroller combination systems.

### BACKGROUND

Foldable strollers are commonly available in the market. Car seat systems and stroller combinations have also been around for a while. Conventional car seat stroller combinations usually include a car seat that is separate from the stroller. The car seat has to be separately transported in and out of a vehicle and installed on the stroller base. These systems are often very bulky and are cumbersome to carry around and transport.

There are some car seat and stroller combination systems that are currently available. However, those systems often need an additional base to be installed in a vehicle in order to fit the car seat in the vehicle. In addition, in an unfolded state, the height of the car seat above the ground for these systems is lower, which can be a bit awkward to manipulate. Further, the design of the available systems results in a less sturdy frame.

### BRIEF DESCRIPTION OF THE DRAWINGS

FIG. 1A illustrates a perspective view of a car seat stroller combination system in accordance with the principles of the present disclosure.

FIG. 1B illustrates a side view of the car seat and stroller combination system in accordance with the principles of the present disclosure.

FIG. 1C illustrates a front view of the car seat and stroller combination system in accordance with the principles of the present disclosure.

FIG. 1D illustrates a back view of the car seat and stroller combination system in accordance with the principles of the present disclosure.

FIG. 1E illustrates a top view of the car seat and stroller combination system in accordance with the principles of the present disclosure.

FIG. 1F illustrates a bottom view of the car seat and stroller combination system in accordance with the principles of the present disclosure.

FIG. 2A illustrates a perspective view of the car seat and stroller combination system in a folded state in accordance with the principles of the present disclosure.

FIG. 2B illustrates a side view of the car seat and stroller combination system in the folded state in accordance with the principles of the present disclosure.

FIG. 2C illustrates a front view of the car seat and stroller combination system in the folded state in accordance with the principles of the present disclosure.

FIG. 2D illustrates a bottom view of the car seat and stroller combination system in the folded state in accordance with the principles of the present disclosure.

FIG. 2E illustrates a top view of the car seat and stroller combination system in accordance with the principles of the present disclosure.

FIG. 2F illustrates a bottom view of the car seat and stroller combination system in accordance with the principles of the present disclosure.

FIGS. 3A-3C illustrate details of a lock and release mechanism for the car seat and stroller combination system in accordance with the principles of the present disclosure.

FIGS. 3D-3G illustrate an alternative locking mechanism for the car seat and stroller combination system in accordance with the principles of the present disclosure.

FIGS. 4A-4F illustrate an operation of the car seat and stroller combination system in accordance with the principles of the present disclosure.

FIGS. 5A-5C illustrate different mechanisms to secure the car set and stroller combination system to a vehicle in accordance with the principles of the present disclosure.

FIG. 6A illustrates a perspective view of a car seat and stroller combination in an unfolded state in accordance with the principles of the present disclosure.

FIG. 6B illustrates a side view of the car seat and stroller combination system in the unfolded state in accordance with the principles of the present disclosure.

FIG. 6C illustrates a front view of the car seat and stroller combination system in the unfolded state in accordance with the principles of the present disclosure.

FIG. 6D illustrates a back view of the car seat and stroller combination system in the unfolded state in accordance with the principles of the present disclosure.

FIG. 6E illustrates a top view of the car seat and stroller combination system in the unfolded state in accordance with the principles of the present disclosure.

FIG. 6F illustrates a bottom view of the car seat and stroller combination system in the unfolded state in accordance with the principles of the present disclosure.

FIG. 7A illustrates a perspective view of the car seat and stroller combination system in the folded state in accordance with the principles of the present disclosure.

FIG. 7B illustrates a side view of the car seat and stroller combination system in the folded state in accordance with the principles of the present disclosure.

FIG. 7C illustrates a back view of the car seat and stroller combination system in the folded state in accordance with the principles of the present disclosure.

FIG. 7D illustrates a front view of the car seat and stroller combination system in the folded state in accordance with the principles of the present disclosure.

FIG. 7E illustrates a top view of the car seat and stroller combination system in the folded state in accordance with the principles of the present disclosure.

FIG. 7F illustrates a bottom view of the car seat and stroller combination system in the folded state in accordance with the principles of the present disclosure.

FIGS. 8A-8D illustrate a detachable car seat and stroller assembly in accordance with the principles of the present disclosure.

FIG. 9A illustrates a perspective view of a reclineable car seat and stroller combination assembly in an unfolded state in accordance with the principles of the present disclosure.

FIG. 9B illustrates a side view of the reclineable car seat and stroller combination assembly in an unfolded state in accordance with the principles of the present disclosure.

FIG. 9C illustrates the reclining mechanism of the reclineable car seat and stroller combination assembly in an unfolded state in accordance with the principles of the present disclosure.

FIG. 10A illustrates a perspective view of the reclineable car seat and stroller combination assembly in a folded state in accordance with the principles of the present disclosure.

FIG. 10B illustrates a side view of the reclineable car seat and stroller combination assembly in a folded state in accordance with the principles of the present disclosure.

FIG. 11A illustrates a perspective view of a detachable car seat and stroller combination system in an unfolded state in accordance with the principles of the present disclosure.

FIG. 11B illustrates a side view of the detachable car seat and stroller combination system in the unfolded state in accordance with the principles of the present disclosure.

FIG. 11C illustrates a close-up view of a portion of the leg assembly of the detachable car seat and stroller combination system in accordance with the principles of the present disclosure.

FIG. 11D illustrates a close-up view of a portion of the bottom side of the car seat shell of the detachable car seat and stroller combination system in accordance with the principles of the present disclosure.

FIG. 11E illustrates a close-up view of the other portion of the attachment mechanism of the detachable car seat and stroller combination system in accordance with the principles of the present disclosure.

FIG. 12 illustrates a perspective view of a car seat and stroller combination system in accordance with the principles of the present disclosure.

FIGS. 13A-13D illustrate two side views, a back view, and front view, respectively of the car seat and stroller combination system in an unfolded state in accordance with the principles of the present disclosure.

FIG. 14 and FIGS. 15A-15D show various views of the car seat and stroller combination system in a folded state in accordance with the principles of the present disclosure.

FIG. 16 illustrates a handle assembly for a stroller in accordance with the principles of the present disclosure.

FIG. 17 illustrates a view of a portion of the hub assembly in accordance with the principles of the present disclosure.

FIG. 18 illustrates a partial view of the hub assembly in accordance with the principles of the present disclosure.

FIG. 19 illustrates a partial view of the portion as seen from the other side of the portion in accordance with the principles of the present disclosure.

FIGS. 20A-20C illustrate the function of the handle assembly when the handle assembly is rotated between three positions in accordance with the principles of the present disclosure.

FIGS. 21A-21C illustrate the operation of the handle assembly when the handle assembly is telescoped out or retracted in accordance with the principles of the present disclosure.

FIGS. 22A and 22B illustrate a mechanism that may be used the car seat and stroller combination system to ensure that the logo plate remains stationary at all times and does not rotate along with the handle assembly of the car seat and stroller combination system, in accordance with the principles of the present disclosure.

FIGS. 23A and 23B illustrate a handle assembly of a car seat and stroller combination system in accordance with the principles of the present disclosure.

FIG. 24 illustrates a partial view of the hub assembly, and the internal components disposed in the second member in accordance with the principles of the present disclosure.

FIGS. 25A and 25B illustrate details of the slider assembly in accordance with the principles of the present disclosure.

FIGS. 26A and 26B illustrate details of the guide lock in accordance with the principles of the present disclosure.

FIG. 27 illustrates a scenario showing how the slider assembly, the guide lock, and the primary lock are positioned with respect to each other in accordance with the principles of the present disclosure.

FIG. 28 illustrates a view of a hub cover assembly of the handle assembly in accordance with the principles of the present disclosure.

FIGS. 29A-29D illustrate the operation of the handle assembly in four different modes in accordance with the principles of the present disclosure.

FIGS. 30A-30D illustrates various views of a car seat shell assembly with a movable rib in accordance with the principles of the present disclosure.

FIGS. 31A-31D illustrate a process for attaching soft goods to the car seat shell assembly of FIGS. 30A-30D, in accordance with the principles of the present disclosure.

The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

The various car seat and stroller combination systems described herein advantageously are compact when folded and provide the user with enhanced performance and ease of storage and transport while also offering a higher seat position for better maneuverability. The present disclosure includes non-limiting embodiments of car seat and stroller combination systems. The embodiments are described in detail herein to enable one of ordinary skill in the art to practice the various car seat and stroller combination systems, although it is to be understood that other embodiments may be utilized and that logical changes may be made without departing from the scope of the disclosure. Reference is made herein to the accompanying drawings illustrating some embodiments of the disclosure, in which use of the same reference numerals indicates similar or identical items. Throughout the disclosure, depending on the context, singular and plural terminology may be used interchangeably.

The meanings of the terms used herein will be apparent to one of ordinary skill in the art or will become apparent to one of ordinary skill in the art upon review of the detailed description when taken in conjunction with the several drawings and the appended claims.

Embodiments of the present disclosure include a car seat and stroller system that includes a car seat shell, a pair of front legs fixedly connected to the car seat shell, and a pair of back legs fixedly connected to the car seat shell. The car seat and stroller system is configured to be placed in an unfolded state and a folded state. In the unfolded state, the pair of front legs are disposed toward a front end of the car seat and stroller system and the pair of back legs are disposed toward an opposing back end of the car seat and stroller system and in the folded state, the pair of front legs are disposed toward the back end of the car seat and stroller system and the pair of back legs are disposed toward the front end of the car seat and stroller system.

Other embodiments of the present disclosure provide a car seat and stroller system that includes at least one first leg that is disposed toward a front side of the car seat and stroller system, a pair of second legs that are disposed toward a back side of the car seat and stroller system, and a car seat shell coupled to the first leg and the pair of back legs. A first end of the first leg is connected to the car seat shell at a first hinged connection point, a second end of first leg is coupled to a first wheel, a first end of each of the second legs is coupled to a second wheel, and a second end of each of the second legs is connected to the car seat and stroller system at a second hinged connection point. The first leg is rotatable around a first axis passing through the first hinged connection point and the second leg is rotatable around a second axis passing through the second hinged connection point.

In yet another embodiment, a car seat and stroller system is provided that includes a car seat shell assembly and a leg assembly detectably connected to the car seat shell assembly.

The leg assembly further includes a pair of front legs including a first leg and a second leg, and a pair of back legs including a third leg and a fourth leg. The first leg and the third leg are disposed on a first side of the car seat shell assembly, and the second leg and the fourth leg are disposed on a second side of the car seat shell assembly. The leg assembly further includes a first transverse member extending between the first leg and the third leg, a second transverse member extending between the second leg and the fourth leg, a first wheel connected to the first leg, a second wheel connected to the second leg, a third wheel connected to the third leg, and a fourth wheel connected to the fourth leg. The car seat and stroller system is configured to be placed in an unfolded state and a folded state. In the unfolded state, the first wheel and the third wheel are disposed at a front end of the car seat and stroller system and the second wheel and the fourth wheel are disposed at a back end of the car seat and stroller system. In the folded state, the first wheel and the third wheel are disposed at the back end of the car seat and stroller system, and the second wheel and the fourth wheel are disposed at the front end of the car seat and stroller system.

In yet another embodiment, a car seat and stroller system is provided that includes a car seat shell, a pair of connection brackets pivotably attached to the car seat shell, a pair of front legs fixedly coupled to the car seat shell, and a pair of back legs fixedly coupled to the car seat shell, wherein the car seat and stroller system is configured to be placed in an unfolded state and a folded state. In the unfolded state, the pair of front legs are disposed toward a front end of the car seat and stroller system and the pair of back legs are disposed toward an opposing back end of the car seat and stroller system and in the folded state, the pair of front legs are disposed toward the back end of the car seat and stroller system and the pair of back legs are disposed toward the front end of the car seat and stroller system.

In another embodiment, a car seat and stroller system is provided. The car seat and stroller system includes a first pair of legs, a second pair of legs, a car seat shell coupled to the first pair legs and the second pair of legs, a pair of connection brackets pivotably attached to the car seat shell, a first pair of wheels connected to the first pair of legs, and a second pair of wheels connected to the second pair of legs. In an unfolded state of the car seat and stroller system, the first pair of legs are disposed toward a front end of the car seat and stroller system and the second pair of legs are disposed toward an opposing back end of the car seat and stroller system; and in a folded state of the car seat and stroller system, the first pair of legs are disposed toward the back end of the car seat and stroller system and the second pair of legs are disposed toward the front end of the car seat and stroller system.

In yet another embodiment, a car seat and stroller system is provided that includes a car seat shell and a handle assembly connected to the car seat shell. The handle assembly further includes a first member including a button, a handle mode plate mechanically coupled to the button, the handle mode plate including a first pin, a second member coupled to the first member, and a hub assembly coupled to the second member, wherein the hub assembly is connected to the car seat shell. The hub assembly may further include a master plate having a slot and a plurality of recessed regions, and a handle lock pin assembly coupled to the master plate and having a second pin and a third pin.

The present disclosure provides details on a few types of foldable car seat and stroller combination systems, but one skilled in the art will realize that other types of car seat and stroller combination systems may also be manufactured using the systems and methods provided in this disclosure.

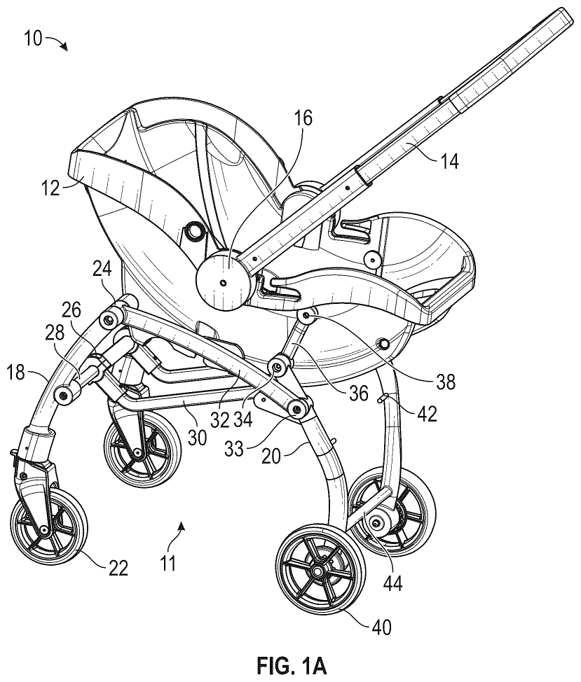

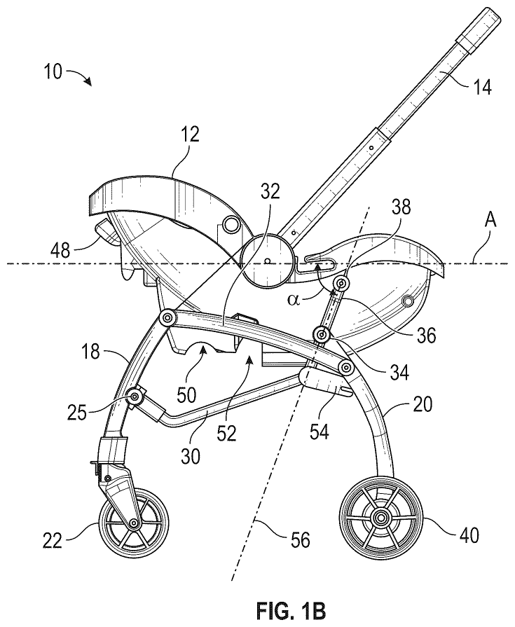

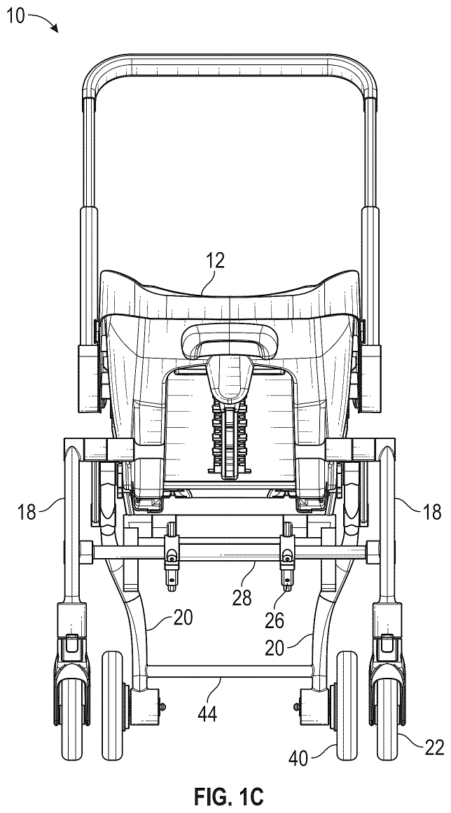

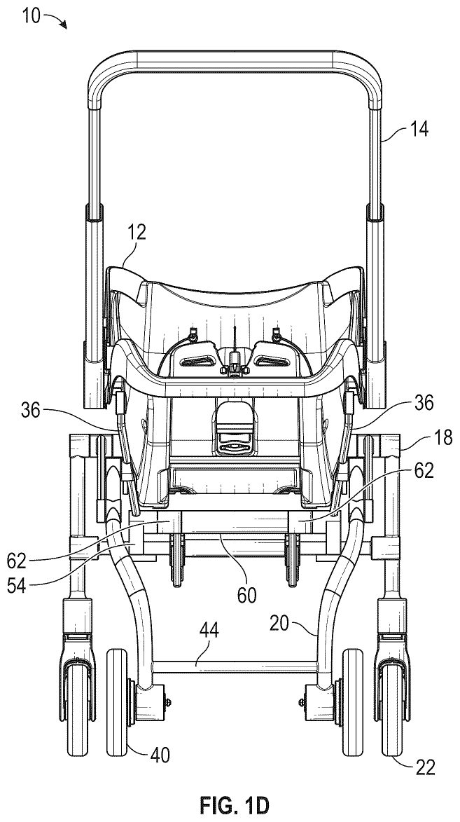

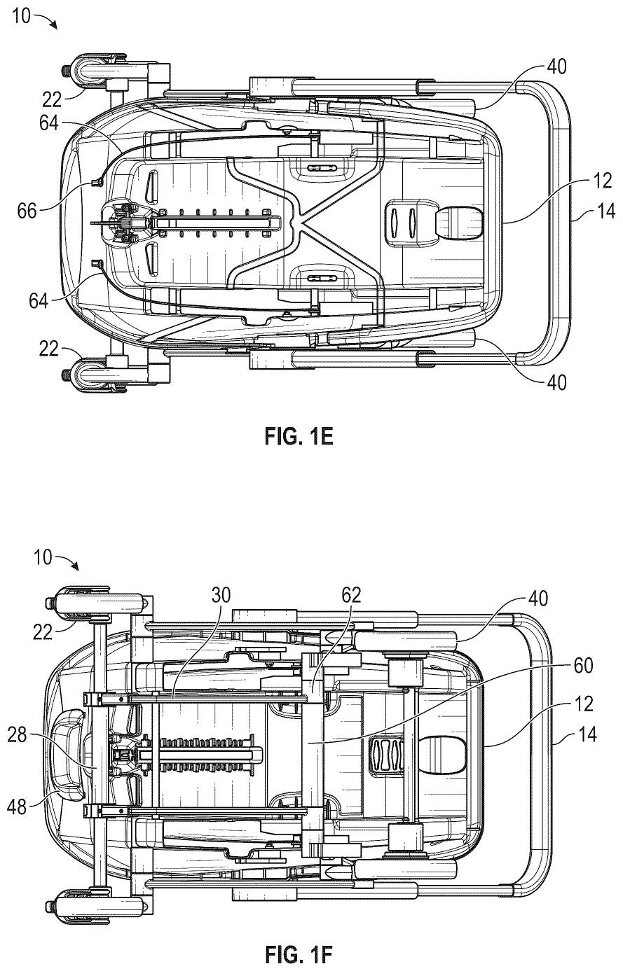

FIG. 1A illustrates a perspective view of a car seat and stroller combination system 10 according to an embodiment of the present disclosure and FIG. 1B illustrates a side view of the car seat and stroller combination system 10 according to an embodiment of the present disclosure. The following disclosure is provided with reference to both FIGS. 1A and 1B. The car seat and stroller combination system 10 includes a car seat shell 12 fixedly attached to a leg assembly 11. The car seat shell 12 includes a telescoping handle 14 attached to the car seat shell 12 at a connection point 16 along each side of the car seat shell 12. The telescoping handle 14 can be used to maneuver the car seat and stroller combination system 10. The telescoping handle 14 is movable radially and can be placed in one or more positions along a radial path. The leg assembly 11 may include a pair of front legs 18 and a pair of back legs 20. Each of the front legs 18 has a swivelable front wheel 22 attached to a first end of the front leg 18. An opposing second end of each of the front legs 18 is attached to a lower side of the car seat shell 12 at a corresponding front leg attachment point 24. Each of the back/rear legs 20 has a back wheel 40 attached to a first end of the back leg 20. An opposing end of each of the back legs 20 is attached to the lower side of the car seat shell 12 at a corresponding back leg attachment point 34 on a fixed-point member 36. In an embodiment, the front wheels 22 are smaller in diameter than the back wheels 40. In another embodiment, the back wheels 40 are fixed and not swivelable. In yet another embodiment, the various components of the car seat and stroller combination system 10 can be manufactured using materials that include one or more of plastic, metal, rubber, polycarbonate, or the like.

The car seat and stroller combination system 10 further includes a fixed-point member 36 that extends between the back leg attachment point 34 and fixed attachment point 38 on the fixed-point member 36. A first cross-link member 32 extends between the front leg attachment point 24 and an intermediate attachment point 33 located on the back leg 20. The intermediate attachment point 33 is located between the back leg attachment point 34 and the back wheel 40 along the back leg 20. A transverse member 28 extends horizontally between the two front legs 18 and connects the two front legs 18 to each other. A pair of U-shaped cross-link members 30 extend between the transverse member 28 and couples to the fixed-point member 36 near corresponding connection points 56 on the fixed-point member 36. Each of the U-shaped cross-link member 30 connects to the transverse member 28 at a corresponding connection point 26 located on the transverse member 28. The transverse member 28 connects to each of the front legs 18 at corresponding connection points 25 located on the each of the front legs 18. Each latch mechanism 54 of a pair of latch mechanisms is movably connected to the fixed-point member 36 at the corresponding connection points 56. Thus, in one embodiment, the fixed-point member 36 has three connection points. The back legs 20 each may include a locking pin 42 that engages with a locking mechanism (described below) when in the folded state to secure the back legs in place.

The car seat and stroller combination system 10 further includes a latch release handle 48 located along a front surface of the car seat shell 12. Operation of the latch release handle 48 enables the leg assembly 11 to be folded in an accordion style as will be explained below in detail. The car seat shell 12 further includes a first recessed region 50 and a second recessed region 52 located along a lower side of the car seat shell 12. The first recessed region 50 and the second recessed region 52 are configured to receive portions of the front legs 18 and the back legs 20 when the car seat and stroller combination system 10 is placed in a folded configuration. In an embodiment, each of the front leg attachment points 24, the intermediate attachment points 33, the back leg attachment point 34, the fixed attachment points 38, and the connection points 26 are implemented as hinges that can rotate around an axis thereby allowing the front legs 18 and the back legs 20 to fold on opposite sides in an accordion-style configuration. The car seat and stroller combination system 10 further includes a transverse member 44 extending between the two back legs 20. The transverse member 44 provides rigidity and mechanical strength to the car seat and stroller combination system 10. Similarly, the U-shaped cross-link members 30, the first cross-link members 32, and the transverse member 28 all provide rigidity and mechanical strength to the car seat and stroller combination system 10. In an embodiment, in the unfolded state or position, the fixed-point member 36 is at an angle α with respect to an axis “A” that runs parallel to a ground plane. The angle α is an acute angle being less than 90 degrees. Further, the connection point 16 where the telescoping handle 14 is attached to the car seat shell 12 is not connected to any portion of the front legs 18 or the back legs 20. The connection point 16 is located higher than any of the components of the leg assembly 11.

FIG. 1C illustrates a front view of the car seat and stroller combination system 10 in the unfolded state according to an embodiment of the present disclosure. In the unfolded state, when viewed from the front, the horizontal distance between the two front wheels 22 is more than a horizontal distance between the two back wheels 40. In other words, a length of the transverse member 28 extending between the two front legs 18 is more than the length of the transverse member 44 extending between the two back legs 20. Further, the two back legs 20 are not straight, but rather have an arched shaped having a certain curvature. Similarly, the front legs 18 too are not straight and have an arched shaped with a curvature. The arched shapes of the front legs 18 and the back legs 20 enable the car seat and stroller combination system 10 to be folded into a compact shape. FIG. 1D illustrates a back view of the car seat and stroller combination system 10 according to an embodiment of the present disclosure. As can be seen, both the back wheels 40 are located within the width of the two front wheels 22. A transverse member 60 extends between the two fixed point members 36. The second end of the U-shaped cross link member 30 is connected to the transverse member 60 at respective connection points 62. The latch mechanism 54 is also connected to the transverse member 60 at the connection point 56. In an embodiment, the connection point 62 is located immediately adjacent to the latch mechanism 54.

FIGS. 1E and 1F illustrate a top view and a bottom view, respectively, of the car seat and stroller combination system 10 in the unfolded state according to an embodiment of the present disclosure. The car seat and stroller combination system 10 further includes a pair of pull strings 64 that extend from the latch handle 48 via a connection point 66 to a lock hook (not shown) located at an opposing end of the car seat shell 12. The details of the lock and release mechanism for the car seat and stroller combination system 10 are described in detail below. The lock and release mechanism enables the folding and unfolding of the car seat and stroller combination system 10. The U-shaped cross link member 30 extends between the first transverse member 28 and the second transverse member 60. In an embodiment, the length of the first transverse member 28 is greater than a length of the second transverse member 60. In another embodiment, the first transverse member 28 is parallel to the second transverse member 60.

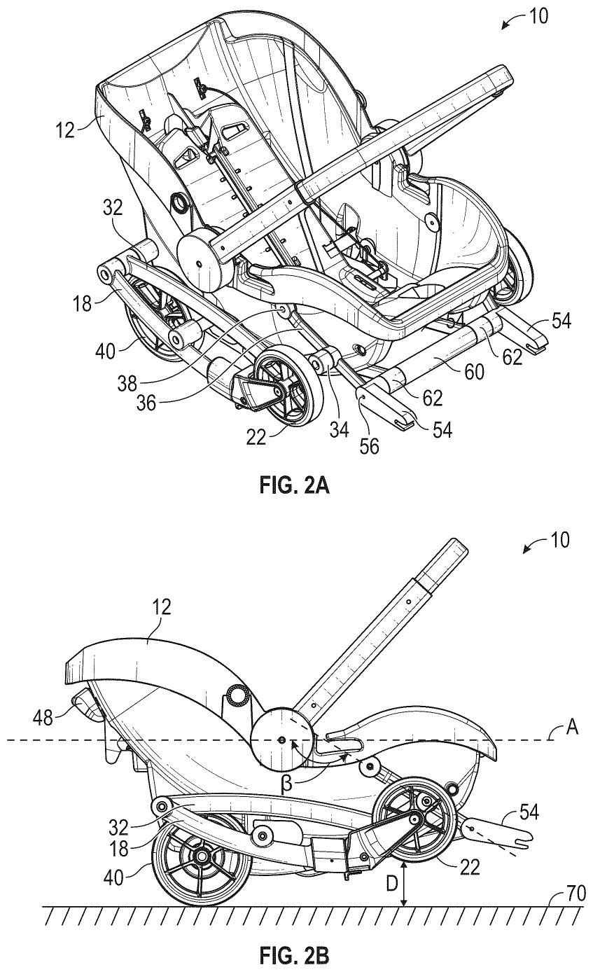

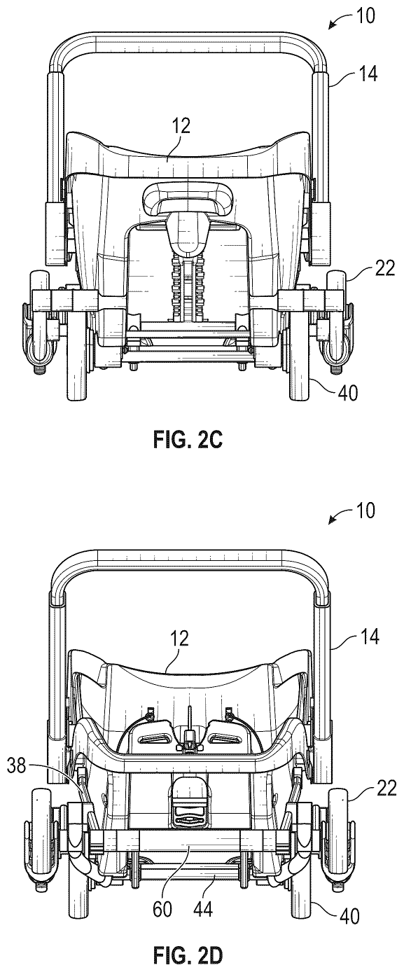

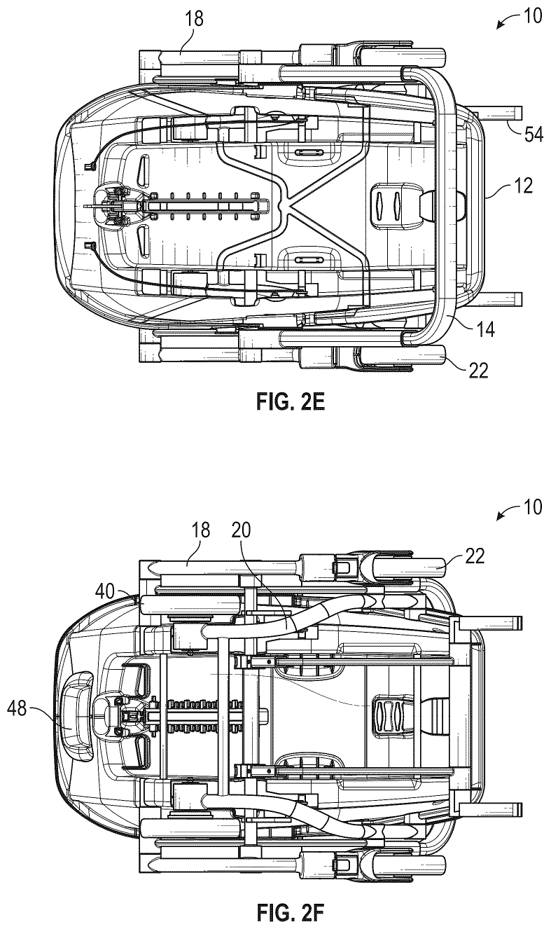

FIG. 2A illustrates a perspective view of the car seat and stroller combination system 10 in folded position according to an embodiment of the present disclosure. As shown, the car seat and stroller combination system 10 includes a transverse member 60 that extends between the two latch mechanisms 54. One end of each of the U-shaped cross link members 30 is connected to the transverse member 28. The other end of each of the two U-shaped cross link members 30 is connected to corresponding connection points 62 along the transverse member 60. In the unfolded state, the front wheels 22 are located toward a front side of the car seat and stroller combination system 10 and the back wheels 40 are located toward a back side of the car seat and stroller combination system 10, as illustrated in FIG. 1A. However, in the folded state, the front wheels 22 are located toward the back side of the car seat and stroller combination system 10 and the back wheels 40 are located toward the front side of the car seat and stroller combination system 10, as illustrated in FIG. 2A. Thus, the front wheels 22 and the back wheels 40 reverse their positions between the unfolded state and the folded state of the car seat and stroller combination system 10. In the folded state, the two latch mechanism 54 are oriented in a direction toward the back side of the car seat shell 12. This enables the latch mechanisms 54 to be engaged with a corresponding vehicle car seat latch system, such as a Lower Anchors and Tethers for Children (LATCH) system or an ISOFix system.

FIG. 2B illustrates a side view of the car seat and stroller combination system 10 in the folded state according to an embodiment of the present disclosure. In the folded state, the fixed-point member 36 is at an angle β with respect to the axis “A”. The angle β is an obtuse angle with a value greater than 90 degrees. In the folded position/state, the back wheels 40 may be disposed along a ground or base plane 70. The front wheels 22 are raised above the ground plane 70 in a vertical direction by a distance “D”. Thus, in the folded state, the front wheels 22 are in a different horizontal plane than the back wheels 40. In some embodiments, the distance “D” is configured to match the contours of a vehicle seat. In most vehicles, the seats are not perfectly flat. Usually, the seat has some gradient or slope from the front end of the seat to a rear end of the seat. The front end of the vehicle seat is usually raised compared to the back end of the vehicle seat. The folded state of the car seat and stroller combination system 10 can conform to this gradient in the seat of a vehicle and sit substantially flat on the vehicle seat without the need for any additional base. This makes the overall car seat and stroller combination system 10 more portable and easy to install and remove from a vehicle. In addition, elimination of the base reduces the overall weight and cost of the car seat and stroller combination system 10 compared to conventional systems that need a base to be installed in a vehicle.

FIGS. 2C and 2D illustrate the front view and back view, respectively, of the car seat and stroller combination system 10 in a folded state according to an embodiment of the present disclosure. In the folded state, the front wheels 22 are raised above the ground and are disposed at a higher elevation compared to the back wheels 40. In the folded state, the transverse member 60 that extends between the fixed-point members 38 is disposed higher than the transverse member 44 that extends between the two back legs 20. This results in a more compact folded structure than the conventional car seat stroller combination systems.

FIGS. 2E and 2F illustrate the top view and a bottom view, respectively, of the car seat and stroller combination system 10 in a folded state according to an embodiment of the present disclosure. As can be seen, in the folded state, a portion of the front legs 18 overlays a portion of the back wheel 40 and the front wheel 22 rests adjacent to the connection point 34.

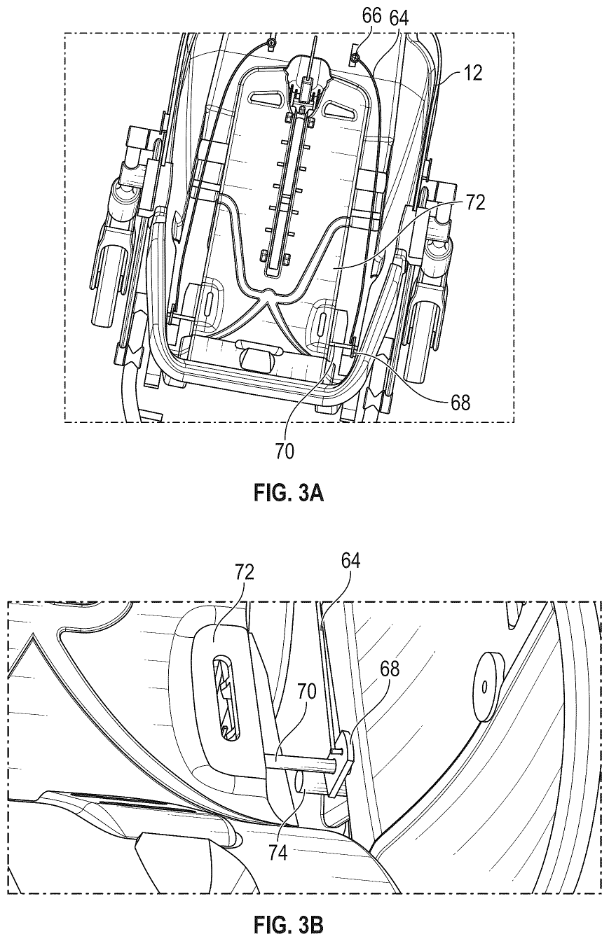

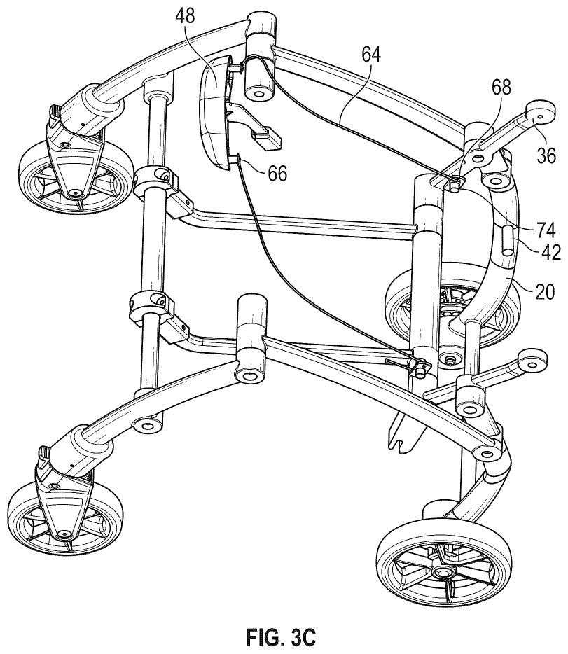

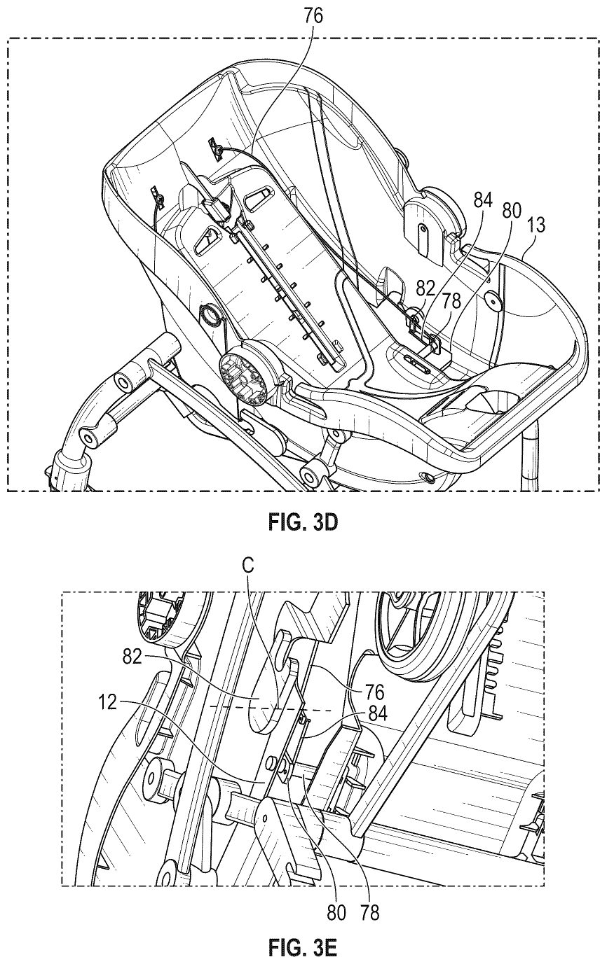

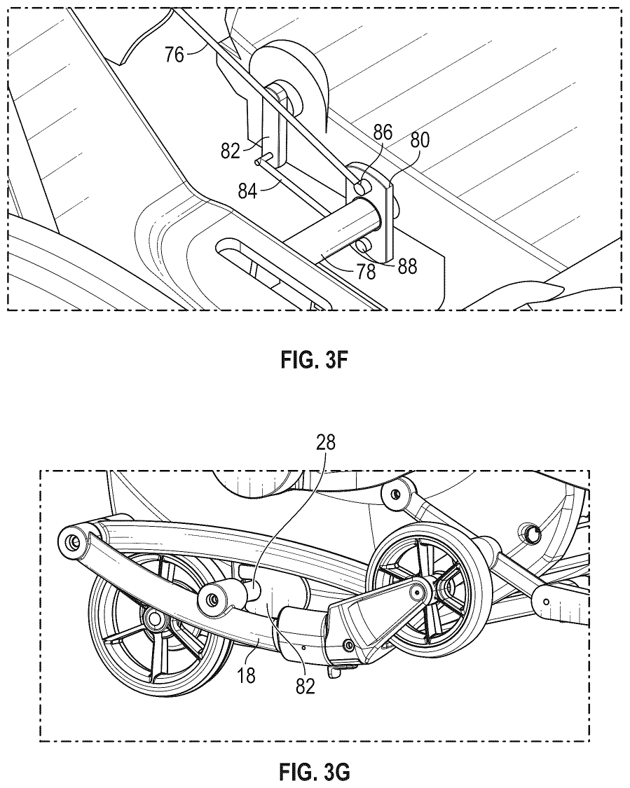

FIGS. 3A-3C illustrate details of a lock and release mechanism for the car seat and stroller combination system 10 according to an embodiment of the present disclosure. The lock and release mechanism includes the latch release handle 48 that is connected to the car seat shell 12 toward a front side of the car seat shell 12. A connection point 66 is coupled to the latch release handle 48. In an embodiment, the connection point 66 may be a screw coupled to a corresponding screw boss of the latch release handle 48. The pull string 64 extends from the connection point 66 to a lock hook 68 and couples the latch release handle 48 to the lock hook 68. The lock hook 68 is coupled to a back portion 72 of the car seat shell 12 via a rigid member 70. In an embodiment, the lock hook 68 may have a hook portion at one end of the lock hook 68 that engages with a lock pin 74 when the car seat and stroller combination system 10 is in the unfolded position. The lock pin 74 is attached to the fixed-point member 36. The car seat and stroller combination system 10 includes a pair of the locking pins 74 each attached to a corresponding fixed-point member 36 of the pair of the fixed point members 36. In the unfolded state, the lock hook 68 engages with the lock pin 74 to secure the back legs 20 into position. For placing the car seat and stroller combination system 10, the latch handle 48 may be activated, e.g., by pulling or extending the handle in a radial direction. The activation of the latch handle 48 causes the pull string 64 to exert a radial force on the lock hook 68 that causes the lock hook 68 to move and release the lock pin 74. This allows the back legs 20 to be folded to bring the locking pin 42 toward the lock hook 68. In the folded state, the lock hook 68 now engages with the locking pin 42 to secure the back legs 20 in place.

FIGS. 3D-3G illustrate an alternative locking mechanism for the car seat and stroller combination system 10 according to another embodiment of the present disclosure. The locking mechanism in this embodiment includes a pair of first pull strings 76 and pair of second pull strings 84 that are attached to a car seat shell 13. The first pull string 76 is longer in length than the second pull string 84. The first pull string 76 extends between the latch handle (not shown) and a plate member 80 that is located at an opposing end of the car seat shell 13. The plate member 80 is coupled to a member 78 that extends between two surfaces of the car seat shell 13 and passes through the plate member 80. The plate member 80 has a through opening, via which the member 78 passes to connect to an anterior surface of the car seat shell 13. As a result, the plate member 80 can freely rotate around an axis that runs along the length of the member 78.

The first pull string 76 is connected at one of its ends to the plate member 80 at a first connection point 86 that is located toward a top end of the plate member 80. The other end of the first pull string 76 is connected to the latch handle. The second pull string 84 is connected at one of its end to the plate member 80 at a second connection point 88 that is located at a bottom end of the plate member 80. The other end of the second pull string 84 is connected to a fold lock hook 82. In an embodiment, the through hole of the plate member 80 through which the member 78 passes is disposed between the first connection point 86 and the second connection point 88.

The fold lock hook 82 is connected to the car seat shell 13 such that a first portion of the fold lock hook 82 is disposed along the outer surface of the car seat shell 13 and a second portion of the fold lock hook 82 is disposed along an anterior surface of the car seat shell 13. The second pull string 84 is connected to the second portion of the fold lock hook 82. The fold lock hook 82 is also rotatable along an axis “C”. In the unfolded state, the fold lock hook 82 does not engage with any portion of the front leg assembly or the back leg assembly as illustrated in FIG. 3E. In the folded state, the fold lock hook 82 engages with the transverse member 28 of the front legs 18 to secure the front legs 18 in place, as illustrated in FIG. 3G. In order to unfold or open the car seat and stroller combination system, the latch handle 48 may be activated. This causes to exert a first pressure in a first direction on the first pull string 76. This causes the plate member 80 to rotate in an anti-clockwise direction around the member 78. The rotation of the plate member 80 exerts a second pressure in a second direction on the fold lock hook 82 via the second pull string 84. In this embodiment, the first direction is opposite to the second direction. The second pressure/force cause the fold lock hook to rotate in an anti-clockwise direction that results in the release of the transverse member 28 from the fold lock hook 82 thereby allowing the front legs 18 to “swing out” and place the car seat and stroller combination system in an unfolded or open state.

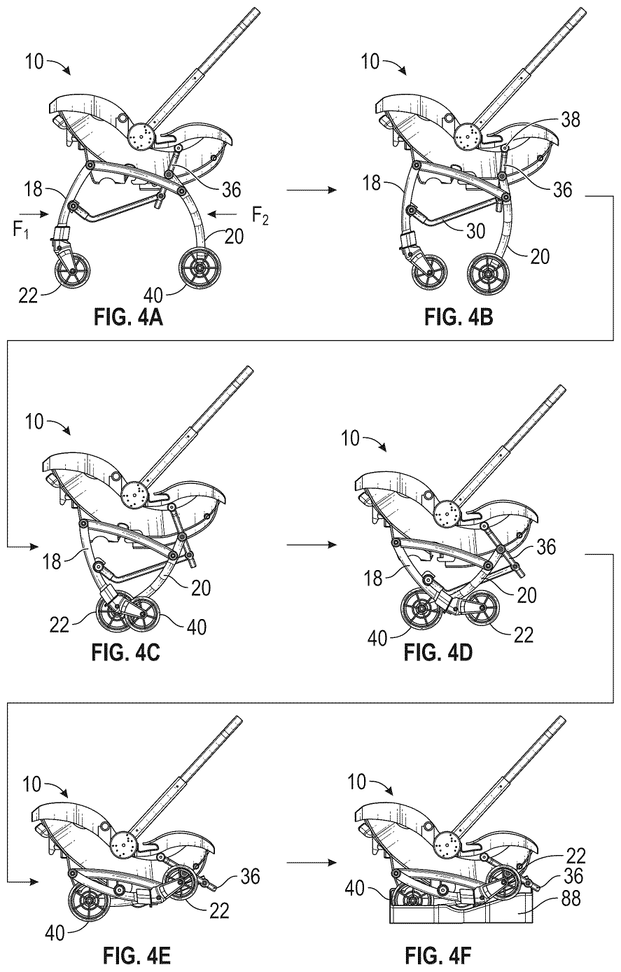

FIGS. 4A-4F illustrate an operation of the car seat and stroller combination system 10 according to an embodiment of the present disclosure. It is to be noted that the identification of “Front” and “Back” in these and other figures are meant for illustration purposes only and to explain the construction and operation of the car seat and stroller combination system 10. Specifically, the FIGS. 4A-4F illustrate a folding operation of the car seat and stroller combination system 10. One skilled in the art will realize that an unfolding operation will involve performance of the steps in a substantially reverse manner and hence the explanation of the unfolding operation is omitted here for brevity. FIG. 4A illustrates the car seat and stroller combination system 10 in an unfolded state in which the front legs 18 and the front wheels 22 are disposed toward the front end of the car seat and stroller combination system 10. The back legs 20 and the back wheels 22 are disposed toward a back end of the car seat and stroller combination system 10. To begin the folding operation, the user may activate the latch release mechanism (not shown) as explained above. In some instances, there may not be a need to activate the latch release mechanism for the folding operation. Upon activation, the latch release mechanism and/or the user may exert a force on the front legs 18, a force on the back legs 20, or exert force on both the front legs 18 and the back legs 20. A first force F₁ may be exerted on the front legs, a second force F₂ may be exerted on the back legs 20, as illustrated by the opposite facing arrows in FIG. 4A. Force F₁ may be applied in a first direction and the force F₂ may be applied in a second direction. In an embodiment, the first direction is opposite to the second direction. In some embodiments, a magnitude of the force F₁ may be same as the magnitude of the force F₂. In other embodiments, the magnitude of the force F₁ may be greater or smaller than the magnitude of the force F₂.

The two opposite forces F₁ and F₂ cause the front legs 18 and the back legs 20, respectively, to move closer toward each other as illustrated in FIG. 4B. During this movement, the fixed-point member 36 also starts to rotate around the connection point 38 causing the U-shaped cross-link member 30 to move slightly in a downward direction. The fixed-point member 36 starts rotating toward the back side of the car seat and stroller combination system 10. As the front legs 18 and the back legs 20 keep moving in opposite directions, at some point during the operation, the front wheels 22 and the back wheels 40 briefly overlap and then travel past each other as illustrated in FIG. 4C. Once the front wheels 22 and the back wheels 40 travel past each other, the front wheels 22 now travel toward the back side of the car seat and stroller combination system 10 and the back wheels 40 travel toward the front side of the car seat and stroller combination system 10, as illustrated in FIG. 4D. The front legs 18 and the back legs 20 also overlap over each other and the back legs 20 are disposed behind the front legs 18 when viewed from the sides of the car seat and stroller combination system 10 as illustrated in FIG. 4E. FIG. 4E illustrates the folded state of the car seat and stroller combination system 10. In this state, the fixed-point member 36 has rotated to now face the back side of the car seat and stroller combination system 10. The locking mechanism may also be activated to secure the front and/or the back legs in place as explained above. In an embodiment, the folded car seat and stroller combination system 10 illustrated in FIG. 4E can then be placed inside the vehicle. In another embodiment, a base 88 may be used such that the base is first placed in the vehicle and the car seat and stroller combination system 10 is then placed on this base 88 and secured in placed, as illustrated in FIG. 4F.

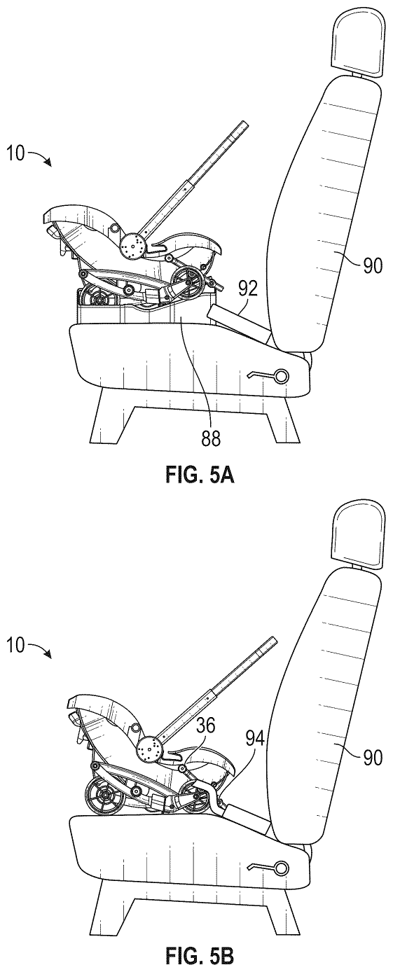

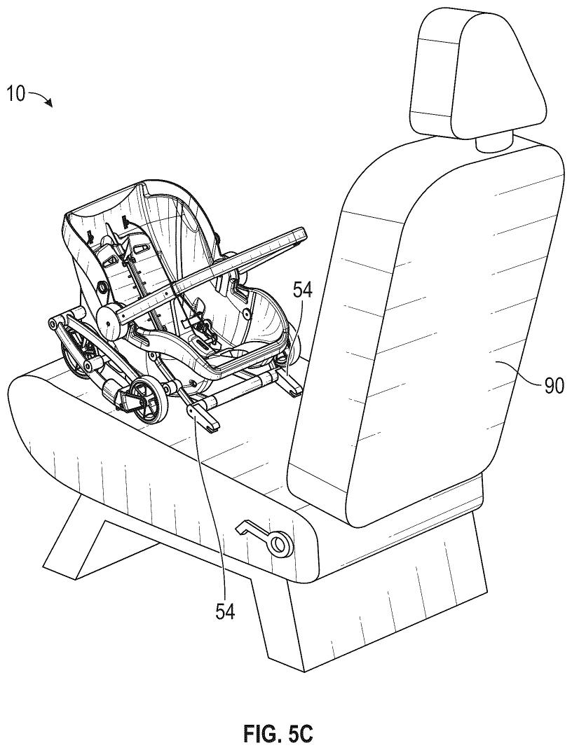

FIGS. 5A-5C illustrate different mechanisms to secure the car set and stroller combination system to a vehicle in accordance with the principles of the present disclosure. FIG. 5A illustrates a first mechanism to secure the car seat and stroller combination system 10 to a vehicle seat 90. In this instance, the car seat and stroller combination system 10 may include the base 88 that is placed on the vehicle seat 90. The base 88 is connected to the vehicle seat 90 via a rigid latch 92 attached to the base 88, e.g., using the ISOFix system. The car seat and stroller combination system 10 is secured to the base 88 via its own latching mechanism. FIG. 5B illustrates a second mechanism to secure the car seat and stroller combination system 10 to a vehicle seat 90. In this instance, a webbing-type latch member 94 may be attached to the fixed-point member 36 of the stroller combination system 10. The latch member 94 may be attached to the vehicle seat 90. In this instance, a base is not needed and the car seat and stroller combination system 10 can be placed directly on the vehicle seat 90. FIG. 5C illustrates a third mechanism of securing the car seat and stroller combination system 10 to the vehicle seat 90. In this instance, the latch mechanism 54 of the car seat and stroller combination system 10 can be engaged with a corresponding latch mechanism of the vehicle seat 90. It is to be understood that the various mechanisms illustrated in FIGS. 5A-5C are exemplary and one skilled in the art will realize that there may be other types of mechanisms that may be used without departing from the spirit of this disclosure.

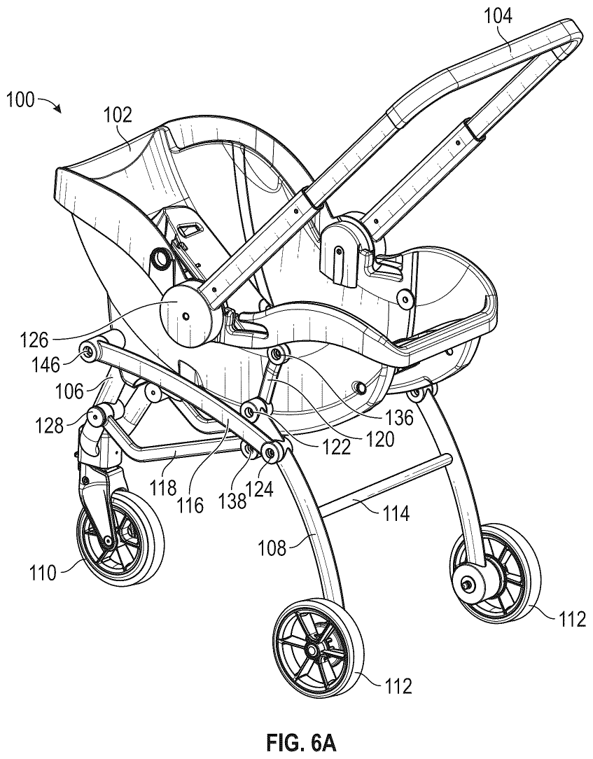

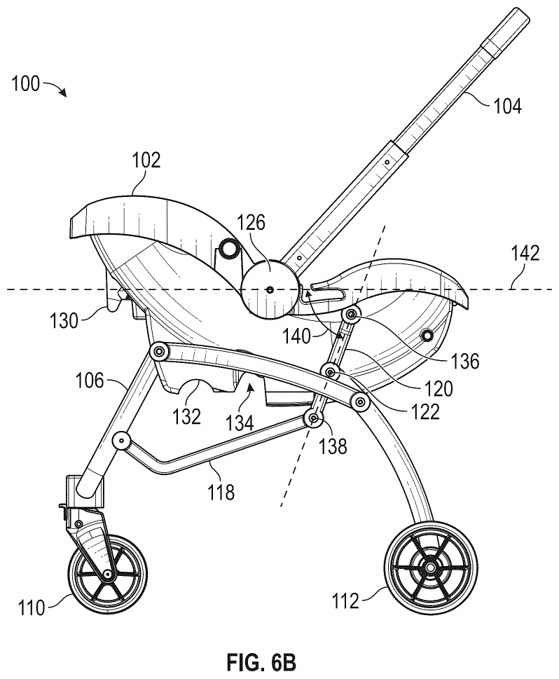

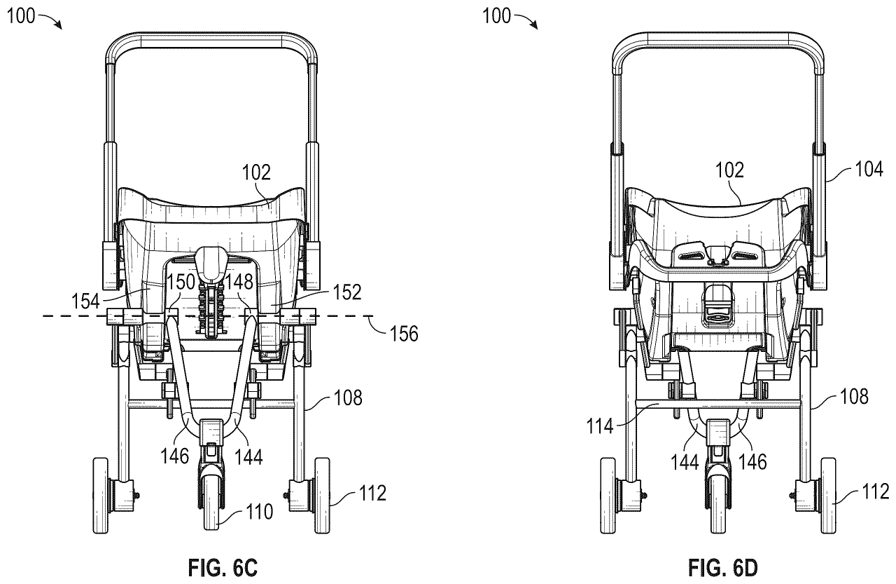

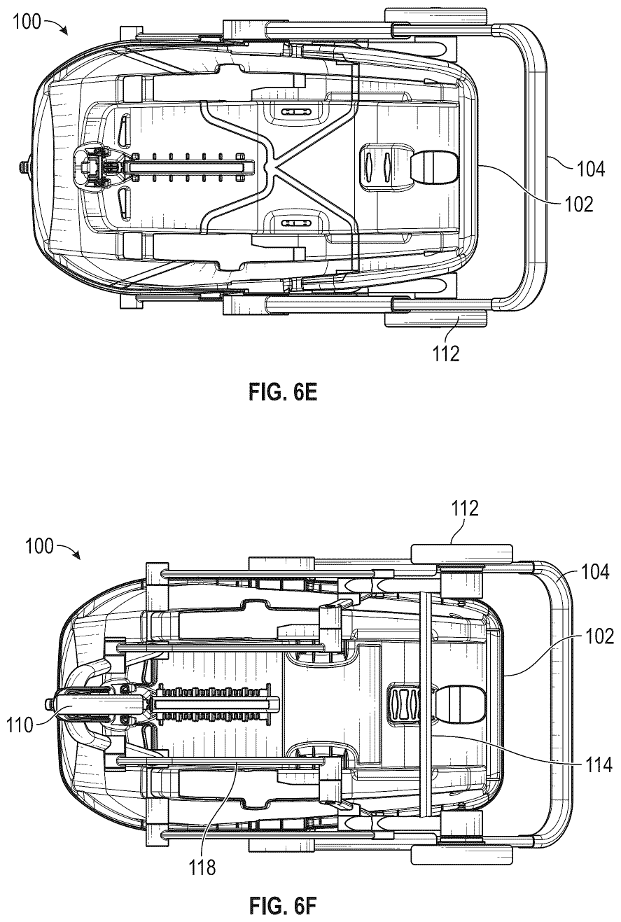

FIG. 6A illustrates a perspective view of a car seat and stroller combination system 100 in an unfolded state according to another embodiment of the present disclosure. The car seat and stroller combination system 100 includes a car seat shell 102. In an embodiment, the car seat shell 102 may be similar to the car seat seal shell 12 illustrated in FIG. 1A. The car seat shell 102 is configured to accommodate a padding for an infant car seat (not shown). The car seat shell 102 includes a telescoping handle 104 that is attached to the car seat shell 102 at a pair of connection points 126 located on either side of the car seat shell 102. The telescoping handle 104 is configured to be moved in an arcuate path and placed in multiple positions along the arcuate path. The car seat and stroller combination system 100 also includes a single front leg 106 and a pair of back legs 108. A single front wheel 110 is connected at one end of the front leg 106. The designations “front” and “back” are used in this disclosure for illustration and explanation purposes only and should not be construed as signifying any specific orientation or direction associated with the car seat and stroller combination system 100.

A first transverse member 114 extends between the two back legs 108. The first transverse member 114 provides mechanical support and rigidity to the car seat and stroller combination system 100. A pair of second transverse members 116 extend from a front portion of the car seat shell 102 to the back legs 108. At a first end, the second transverse members 116 connect to the back legs 108 at corresponding first hinged connection points 124. The first hinged connection points 124 allow the back legs 108 and the second transverse members 116 to rotate around an axis passing horizontally through the first hinged connection points 124. In an embodiment, the second transverse members 116 have a curvature along the length of the second transverse members 116. The second end of the second transverse members 116 are connected to the car seat shell 102 at a corresponding second hinged connection points 146. In an embodiment, the second hinged connection points 146 allow the second transverse members 116 to rotate around a horizontal axis passing through the second hinged connection points 136. A pair of U-shaped cross-link members 118 extend between the front leg 106 and a fixed-point member 120. A first end of each of the U-shaped cross-link member 118 is connected to a corresponding one of a pair of third hinged connection points 128 located on the front leg 106. A second end of each of the U-shaped cross-link member 118 is connected to a corresponding one of a pair of fourth hinged connection point 138 located on the fixed-point member 120. The fixed-point member 120 extends between the second hinged connection point 136 and the fourth hinged connection point 138. One end of the back leg 108 is connected to a fifth hinged connection point 122 disposed on the fixed-point member 120. The other end of each of the back legs 108 is connected to a corresponding back wheel 112 of a pair of wheels. In an embodiment, a diameter of the back wheel 112 is greater than a diameter of the front wheel 110. The fifth hinged connection point 122 is located between the fourth hinged connection point 138 and the second hinged connection point 136 on the fixed-point member 120.

FIG. 6B illustrates a side view of the car seat and stroller combination system 100 according to an embodiment of the present disclosure. As illustrated, the car seat and stroller combination system 100 further includes a latch release handle 130 that is connected to the car seat shell 102 at the front end of the car seat and stroller combination system 100. The latch release handle 130 can be activated to release a corresponding latch (not shown) to either fold or unfold the car seat and stroller combination system 100. The car seat shell 102 further includes a first recessed region 132 and a second recessed region 134 that are located at a bottom side of the car seat shell 102. The second recessed region 134 is configured to accept a portion of the front leg 106 when the car seat and stroller combination system 100 is in the folded state. The first recessed region 132 may be configured to accommodate a portion of a corresponding base in an embodiment. In the unfolded state, the fixed-point member 120 makes an angle 140 with respect to a horizontal axis 142 that is parallel to a ground plane, and which passes through the connection point 126. In an embodiment, the angle 140 is acute having a value equal to or less than 90 degrees. In an embodiment, the front wheel 110 is swivelable while the two back wheels 112 are non-swivelable.

FIGS. 6C and 6D illustrate a front view and the back view, respectively, of the car seat and stroller combination system 100 in the unfolded state according to an embodiment of the present disclosure. As explained above, the car seat and stroller combination system 100 includes a front leg 106. The front leg 106 includes two portions that are a mirror image of each other. A first portion 144 extends between the front wheel 110 and the car seat shell 102 and connects to the car seat shell 102 at a hinged connection point 148. A second portion 146 extends between the front wheel 110 and the car seat shell 102 and connects to the car seat shell 102 at another hinged connection point 150 that is separate from the hinged connection point 148. The hinged connection point 148 is located on a first winged portion 152 of the car seat shell 102, and the hinged connection point is located on a second winged portion 154 of the car seat shell 102. There is an open region between the first winged portion 152 and the second winged portion 154. The hinged connection points 148 and 152 allow rotation of the front leg 106 along the horizontal axis 156. In an embodiment, the various components of the car seat and stroller combination system 100 may be manufactured using plastic, polycarbonate, metal, rubber, or any other suitable material.

FIGS. 6E and 6F illustrate the top view and the bottom view, respectively, of the car seat and stroller combination system 100 in the unfolded state according to an embodiment of the present disclosure. As viewed from the top, the front leg 106 and the front wheel 110 are not visible since they are disposed under the car seat shell 102. The front wheel 110 and the two back wheels 112 are arranged such that they each represent a vertex of a triangle. This arrangement results in a compact car seat and stroller combination while providing the requisite strength and rigidity to the structure.

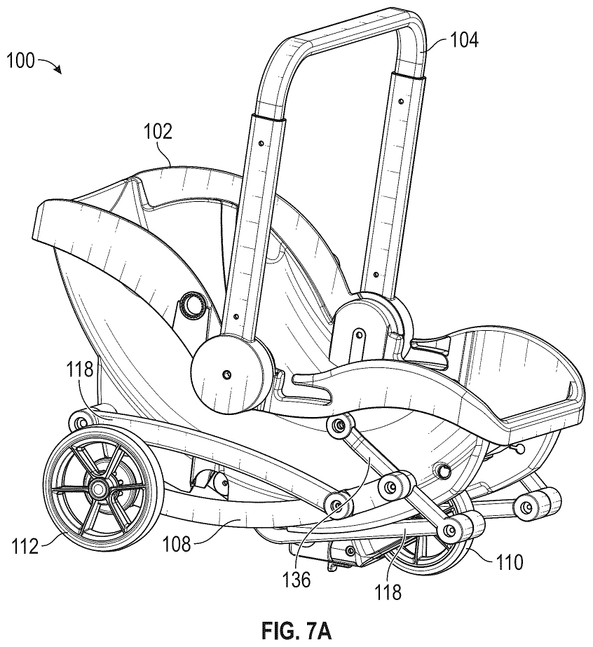

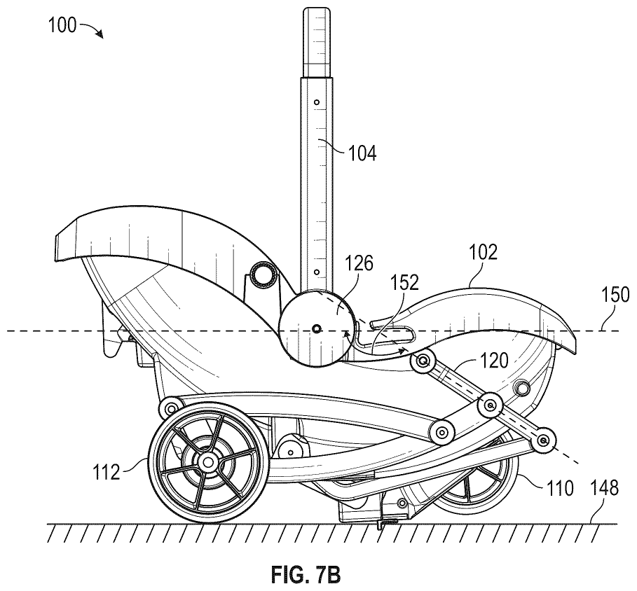

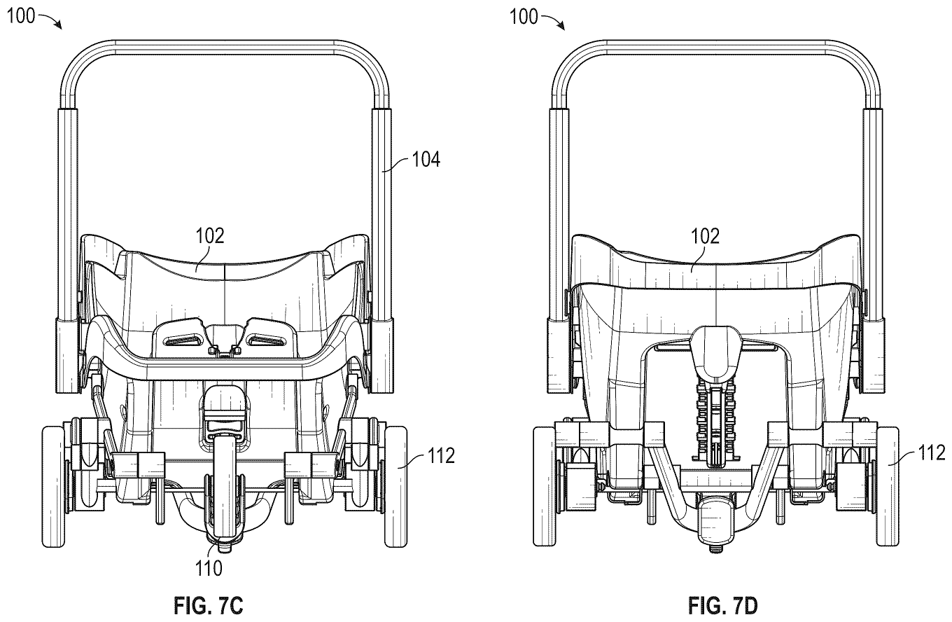

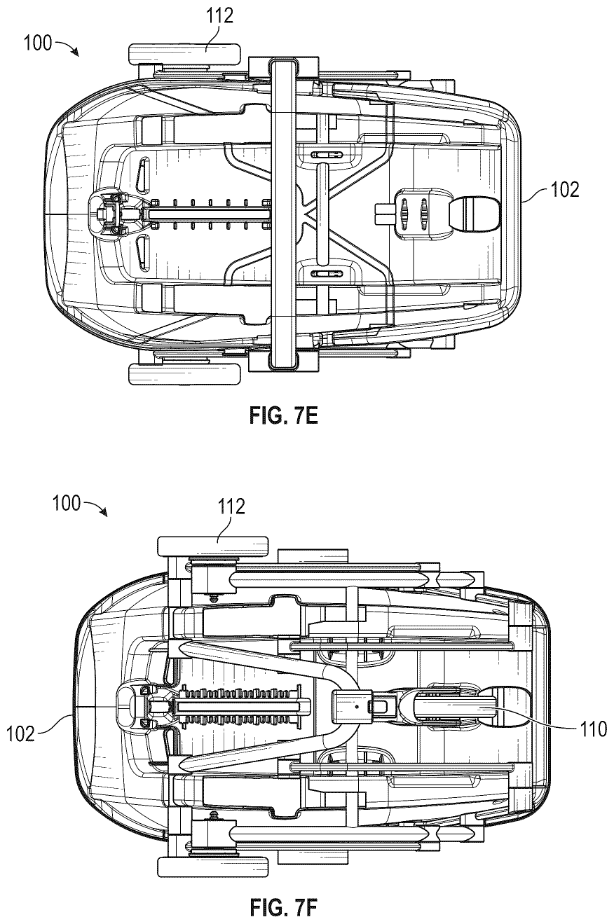

FIG. 7A illustrates a perspective view of the car seat and stroller combination system 100 in the folded state according to an embodiment of the present disclosure and FIG. 7B illustrates a side view of the car seat and stroller combination system 100 in the folded state according to an embodiment of the present disclosure. The following description is provided with reference to both the FIGS. 7A and 7B. The front leg 106 and the back legs 108 are designed to be folded in an accordion-style arrangement such that in the folded state the front leg 106 folds toward the back side of the car seat and stroller combination system 100 and the back legs fold toward the front side of the car seat and stroller combination system 100. Thus, in the unfolded state the front leg 106 is toward the front side of the car seat and stroller combination system 100 and the back legs 108 are toward the back side of the car seat and stroller combination system 100. While in the folded state the front leg 106 is toward the back side of the car seat and stroller combination system 100 and the back legs 108 are toward the front side of the car seat and stroller combination system 100. Further, in the folded state, the front wheel 110 and the back wheels 112 substantially rest along the ground plane 148. In some embodiments, the front wheel 110 may be disposed slightly above the ground plane 148 in a vertical direction in the folded state, as illustrated in FIG. 7B. Further in the folded state, the fixed-point member 120 makes an angle 152 with an axis 150 that runs horizontally through the connection point 126 and parallel to the ground plane 148. In an embodiment, the angle 152 is an obtuse angle having a value of greater than 90 degrees.

FIG. 7C illustrates a back view of the car seat and stroller combination system 100 in the folded state according to an embodiment of the present disclosure and FIG. 7D illustrates a front view of the car seat and stroller combination system 100 in the folded state according to an embodiment of the present disclosure. As can be seen, the front wheel 110 is only visible in the back view of the folded car seat and stroller combination system 100. When observed from the front side, the front wheel 110 is hidden behind a portion of the car seat shell 102, as illustrated in FIG. 7D. This folding mechanism results in a compact folded assembly for the car seat and stroller combination system 100 such that the car seat and stroller combination system 100 can be installed in smaller than usual vehicle seats. This also makes the car seat and stroller combination system 100 lighter in weight compared to the conventional systems and is easier to store and transport.

FIG. 7E illustrates a top view of the car seat and stroller combination system 100 in the folded state according to an embodiment of the present disclosure and FIG. 7F illustrates a bottom view of the car seat and stroller combination system 100 in the folded state according to an embodiment of the present disclosure. In the folded state, the front wheel 110 is disposed in a recessed region at the bottom side of the car seat shell 102. This recessed region is located toward the back side of the car seat shell 102. In the folded state, when the car seat and stroller combination is viewed from a top side, the front wheel 110 is not visible, as illustrated in FIG. 7E.

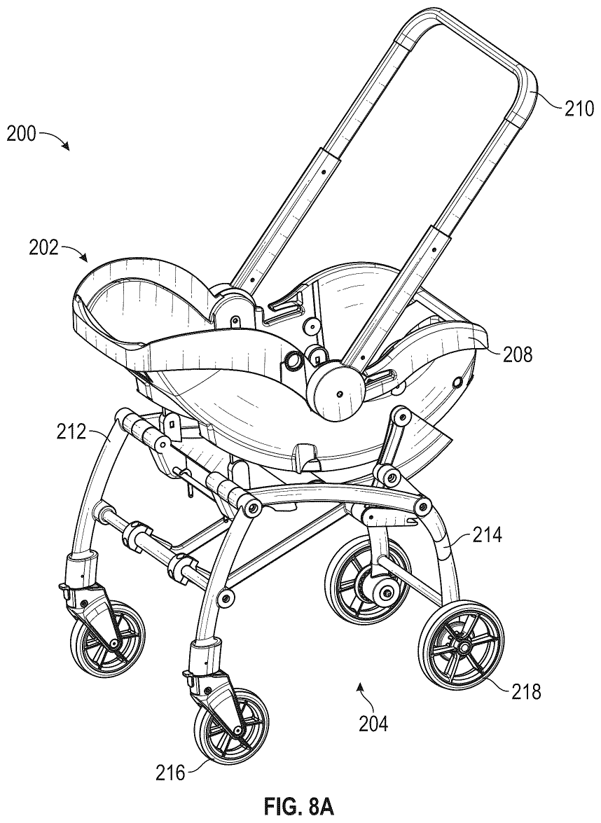

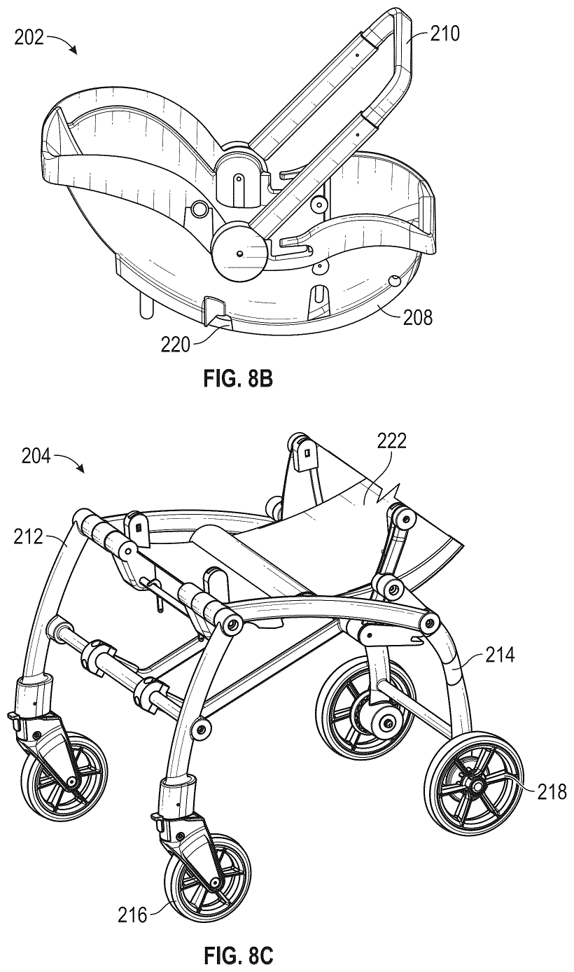

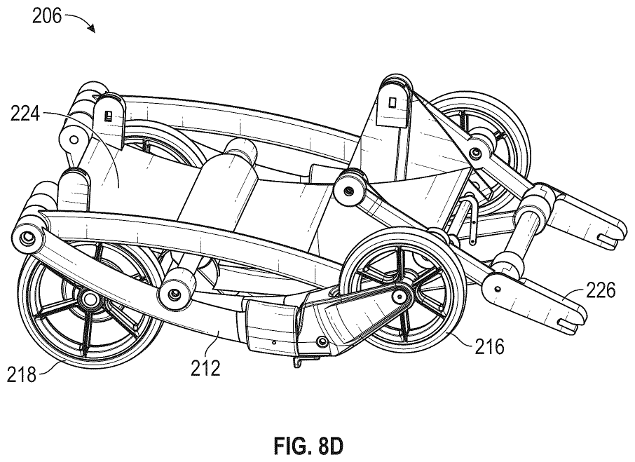

FIGS. 8A-8D illustrate a detachable car seat and stroller assembly 200 according to an embodiment of the present disclosure. The detachable car seat and stroller assembly 200 may include a car seat shell assembly 202 and a leg assembly 204. The car seat shell assembly 202 is removably attached to the leg assembly 204. The car seat shell assembly 202 may include a car seat shell 208 and a telescoping handle 210 attached to the car seat shell 208. In an embodiment, the construction of the car seat shell 208 may be similar to the car seat shell 102 or car seat shell 12 described above with the difference being that while the car seat shell 208 is removably attached to the leg assembly 204, the car seat shell 102 and car seat shell 12 are not removably attached to their respective legs. The leg assembly 204 includes a pair of front legs 212 and a pair of back legs 214. Each front leg of the part of front legs 212 has a front wheel 216 attached to one end of the front leg 212. The other end of each of the front legs 212 is attached to a base portion 222 of the leg assembly 204. The leg assembly 204 also includes a pair of back legs 214. Each back leg 214 of the pair of back legs has a back wheel 218 attached to one end of the back leg 214. The other end of each back leg 214 is attached to the base portion 222. The front legs 212 and the back legs 214 may be similar in construction to the front legs 18 and back legs 20, respectively, as described above. The front legs 212 and the back legs 214 may fold in a similar manner as described above with reference to the other embodiments. The car seat shell 208 may have a suitable attachment mechanism (not shown) that is disposed on a lower side 220 of the car seat shell 208. This attachment mechanism may mate with a complimentary attachment mechanism on the base portion 222 to secure the car seat assembly 202 to the leg assembly 204. In an embodiment, the leg assembly 204 may act as a base for the car seat assembly 202. The leg assembly 204 may have a latching mechanism that enables the leg assembly 204 to be attached to a vehicle seat. Both the attachment mechanisms and the latching mechanism may be implemented using any of the industry standards, such as ISOFix or the like.

FIG. 8D illustrates an alternate leg assembly 206 according to an embodiment of the present disclosure. The leg assembly 206 may have a base portion 224 and a vehicle attachment mechanism 226. The base portion 224 may be configured to accept a corresponding car seat assembly. In the folded state, the leg assembly 206 may be used as a base for the car seat assembly. The vehicle attachment mechanism 226 may be used to attach the leg assembly 206 to a vehicle seat. In an embodiment, the vehicle attachment mechanism 226 may be similar in construction and operation to the latch mechanism 54 described above.

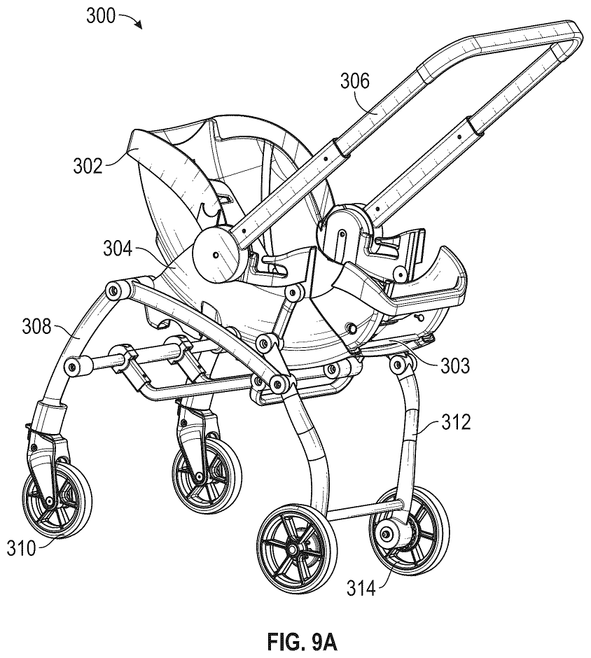

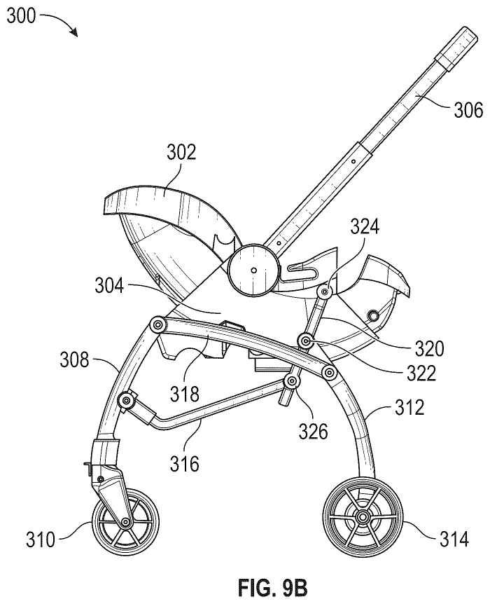

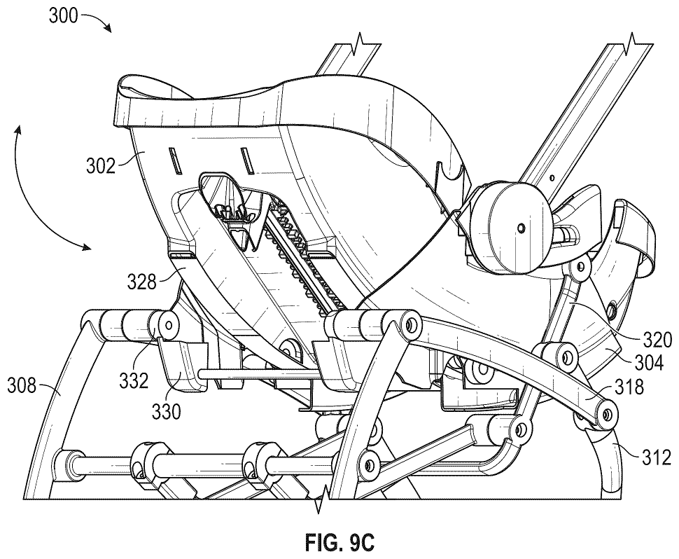

FIG. 9A illustrates a perspective view of a reclineable car seat and stroller combination assembly 300 in an unfolded state according to another embodiment of the present disclosure. The reclineable car seat and stroller combination assembly 300 includes a car seat shell assembly with a moveable portion 302 and a fixed portion 304. The movable portion 302 is disposed partially within the fixed portion 304. The movable portion 304 can be moved in a radial direction to place the car seat shell in a reclined or a non-reclined position. A telescopic handle 306 is coupled to both the movable portion 302 and the fixed portion 304. The reclineable car seat and stroller combination assembly 300 includes a pair of front legs 308. Each front leg 308 has a front wheel 310 attached to one of its ends. The other end of the front legs 308 are connected to the fixed portion 304 of the car seat shell assembly. The reclineable car seat and stroller combination assembly 300 also includes a pair of back legs 312. Each back leg 312 has a back wheel 314 attached to one of its ends. The other end of the back legs 312 is attached to the fixed portion 304 of the car seat shell assembly. In an embodiment, the front legs 308, the front wheels 310, the back legs 312, and the back wheels 314 may be similar in construction and operation to the corresponding components described with reference to the other embodiments above. The fixed portion 304 further includes member 303 disposed at a back end of the car seat shell assembly. This member 303 acts as a hard stop for the movable portion 302 when the car seat shell assembly is placed in its default or non-reclined position.

FIG. 9B illustrates a side view of the reclineable car seat and stroller combination assembly 300 in an unfolded state according to another embodiment of the present disclosure. The reclineable car seat and stroller combination assembly 300 further includes a pair of U-shaped cross-link members 316 that extend between the front legs 308 and a fixed-point member 320. The U-shaped cross-link members 316 connect to the fixed-point member 320 at hinged connection points 326. The reclineable car seat and stroller combination assembly 300 also includes a pair of transverse members 318 that extends between the front legs 308 and back legs 312. The transverse member 318 connected to the fixed portion 304 at the same location where the other end of the front leg 308 is connected to the fixed portion 304. Each back leg 312 connects to the fixed-point member 320 at a corresponding hinged connection point 322. The fixed-point member 320 is connected to the fixed portion 304 at a corresponding hinged connection point 324. The construction and operation of the U-shape cross-link members 316, the fixed-point members 320, and the transverse members 318 may be similar to the corresponding components described above in connection with the other embodiments of this disclosure.

FIG. 9C illustrates the reclining mechanism of the reclineable car seat and stroller combination assembly 300 in an unfolded state according to another embodiment of the present disclosure. As explained above, the front leg 308 and the transverse member 318 both connect to the fixed portion 304 at a connection point 332. The fixed portion includes a U-shaped extension 330 that is disposed in close proximity to the connection point 332. The moveable portion 302 includes a surface 328 disposed on a bottom side of the movable portion 302. In operation, the moveable portion 302 can be radially displaced by use of a small amount of force. When the movable portion 302 is moved in a downward direction as illustrated by the arrow, the surface 328 comes in contact with the U-shaped extension 330. The U-shaped extension 330 acts as a hard-stop for the movement of the movable portion 302. In this position, the car seat shell assembly is in the reclined position. The movable portion 302 may now be moved in the opposite direction as indicated by the arrow until a front portion of the movable portion 302 rests on the member 303 of the fixed portion 304.

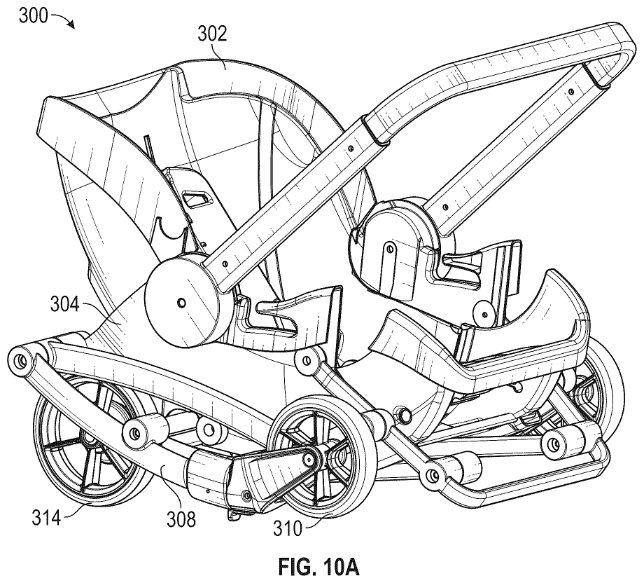

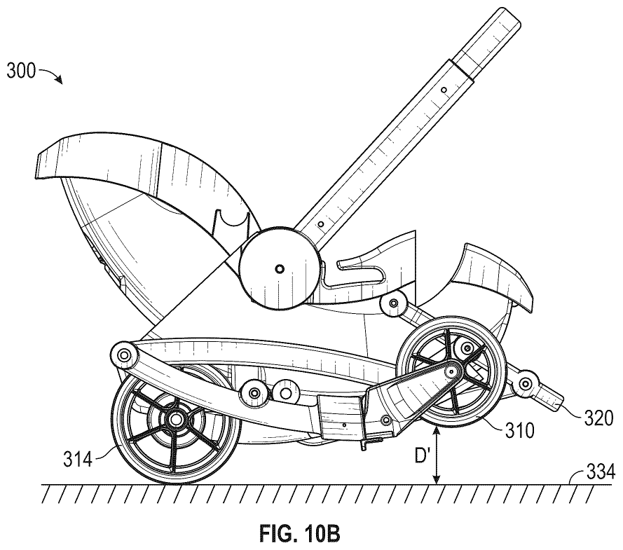

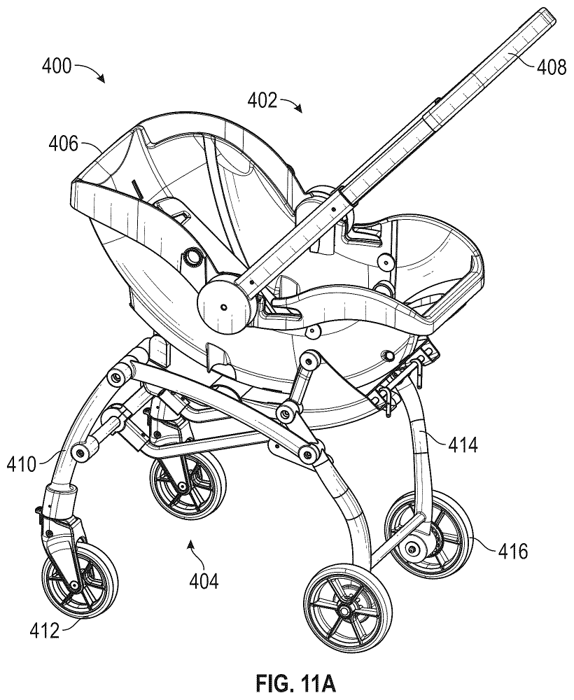

FIG. 10A illustrates a perspective view of the reclineable car seat and stroller combination assembly 300 in a folded state according to another embodiment of the present disclosure. Similar to the other embodiments described above, in the folded state, the front wheels 310 are located toward the back of the car seat shell assembly and the back wheels 314 are located toward the front side of the car seat shell assembly. FIG. 10B illustrates a side view of the reclineable car seat and stroller combination assembly 300 in a folded state according to another embodiment of the present disclosure. As shown in FIG. 10B, in the folded state the front wheels 310 are disposed above a ground plane 334 by a distance D′ that is greater than zero millimeters.

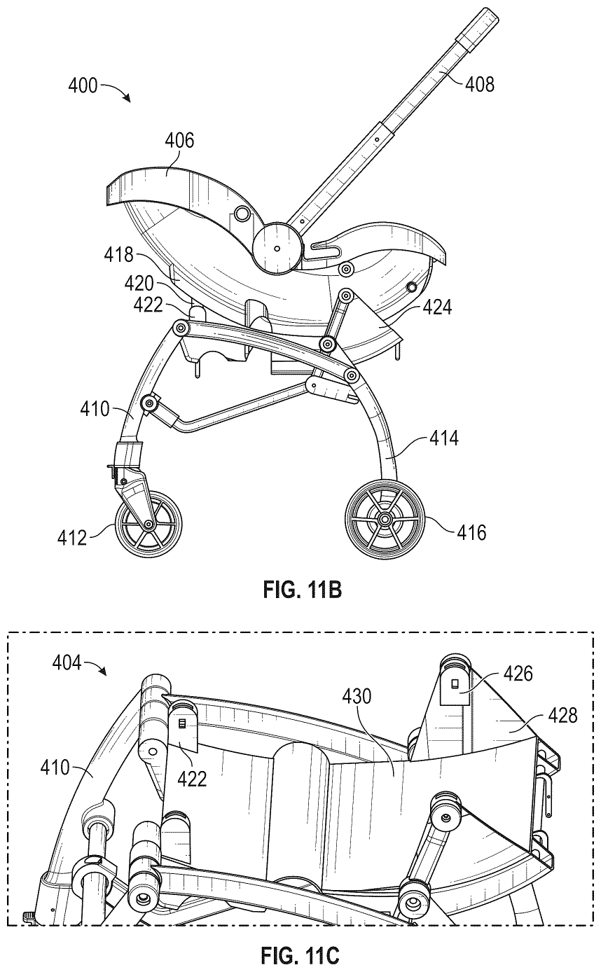

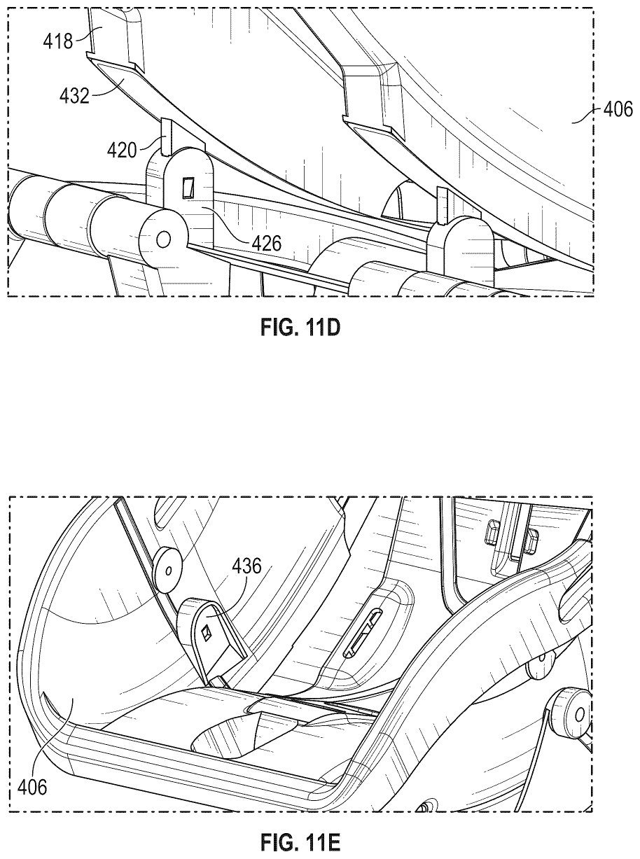

FIG. 11A illustrates a perspective view of a detachable car seat and stroller combination system 400 in an unfolded state according to an embodiment of the present disclosure. The detachable car seat and stroller combination system 400 includes a car seat assembly 402 and a leg assembly 404. The car seat assembly 402 includes a car seat shell 406 and handle 408 attached to the car seat shell. The leg assembly 404 includes a pair of front legs 410 each having a front wheel 412 attached to one end of the front leg 410. The leg assembly 404 also includes a pair of back legs 414 each having a back wheel 416 attached to one end of the back leg 414. The front legs 410, the front wheel 412, the back legs 414, and the back wheels 416 may have a similar construction and operation as any of the corresponding components described above in relation to other embodiments of the present disclosure. The car seat assembly 402 is detachably connected to the leg assembly 404.

FIG. 11B illustrates a side view of the detachable car seat and stroller combination system 400 in the unfolded state according to an embodiment of the present disclosure. The car seat shell 406 includes a pair of ridged surfaces 418 disposed along a bottom side of the car seat shell 406. Each of the ridged surface 418 includes a tab 420 extending from it in a downward direction. Each tab 420 is configured to mate with a corresponding receptacle 422 connected to the leg assembly 404. The tab 420 and the receptacle 422 together form one portion of the attachment mechanism between the car seat assembly 402 and the leg assembly 404. In operation, the tab 420 is inserted into the receptacle 422 until a “click” is heard signaling that the tab is securely in place.

FIG. 11C illustrates a close-up view of a portion of the leg assembly 404 according to an embodiment of the present disclosure. The leg assembly 404 includes a base portion 430 that extends between the pair of front legs 410 and the pair of back legs 414. The two receptacles 422 are disposed closer to the front legs 410 and rise vertically upward from the base portion 430. The base portion 430 also includes two triangular winged portions 428 that are disposed closer to the back legs 414 and rise vertically from the base portion 430. Each of the triangular winged portions 428 includes a second receptacle 426. The receptacle 422 and the second receptacle 426 are part of the attached mechanism for the car seat assembly 402 to the leg assembly 404.

FIG. 11D illustrates a close-up view of a portion of the bottom side of the car seat shell 406 according to an embodiment of the present disclosure. The ridged portion 418 includes a substantially planar surface 432. The tab 420 extends from the surface 432 in a downward direction. The tab 420 is received within the receptacle 426. The receptacle 426 has a slot in which the tab 420 can be inserted. The tab 420 may then snap in place securing the car seat shell 406 to the leg assembly 404. FIG. 11E is a close-up view of the other portion of the attachment mechanism of the detachable car seat and stroller combination system 400 according to an embodiment of the present disclosure. The car seat shell 406 includes a second pair of tabs 436 that can engage with the corresponding second receptacle 426 of the leg assembly 404 to secure the car seat shell 406 to the leg assembly 404. Thus, the tab 420, the second tab 436, the receptacle 422 and the second receptacle 426 together form the attachment mechanism that can secure the car seat assembly 402 to the leg assembly 404.

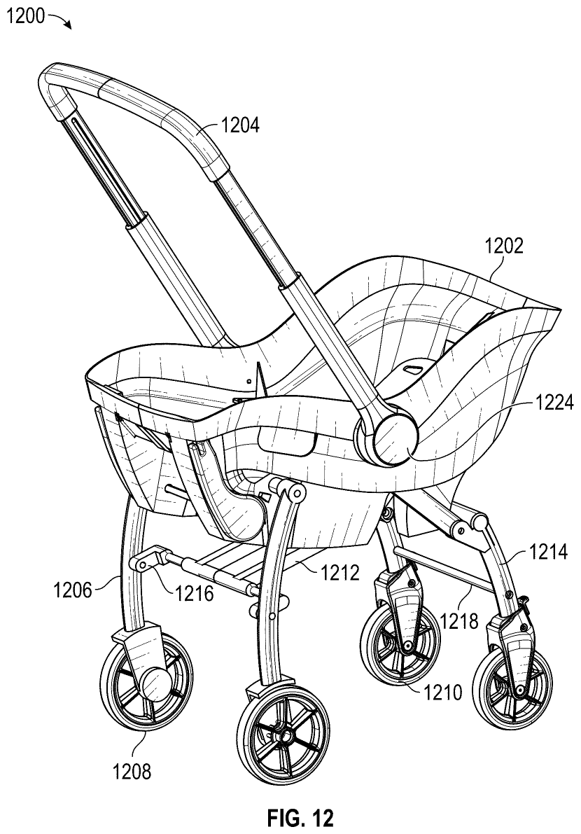

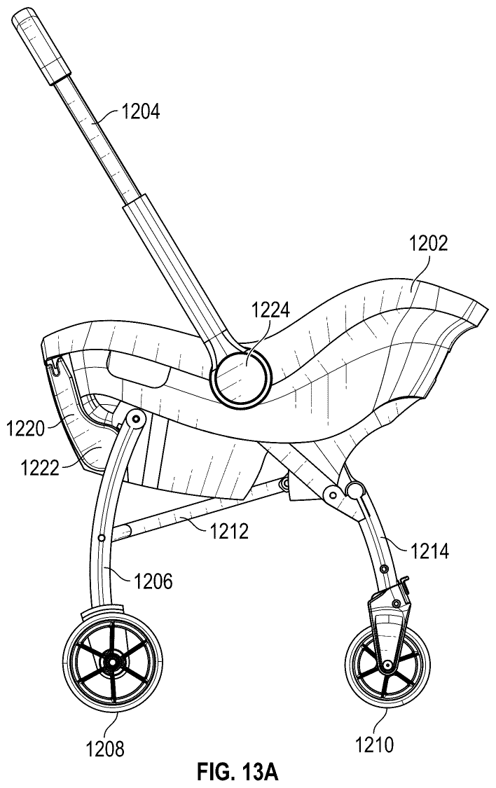

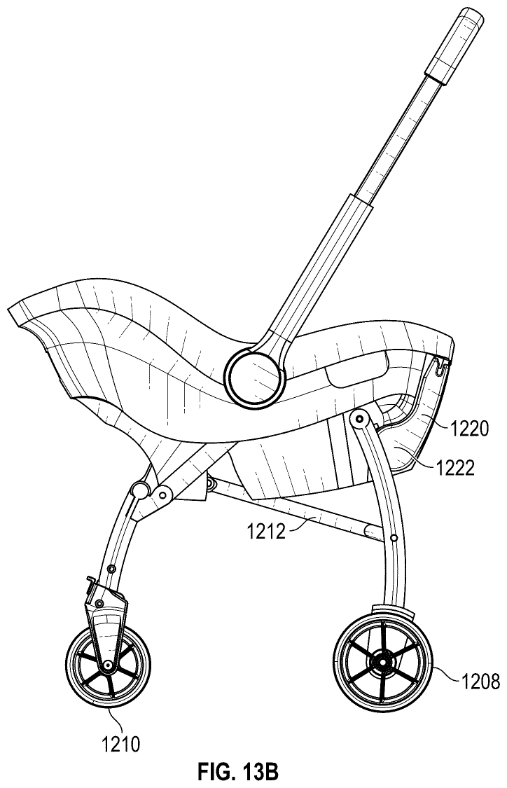

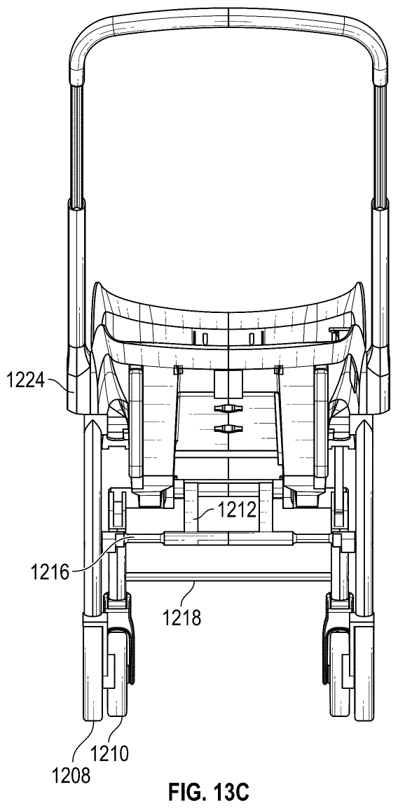

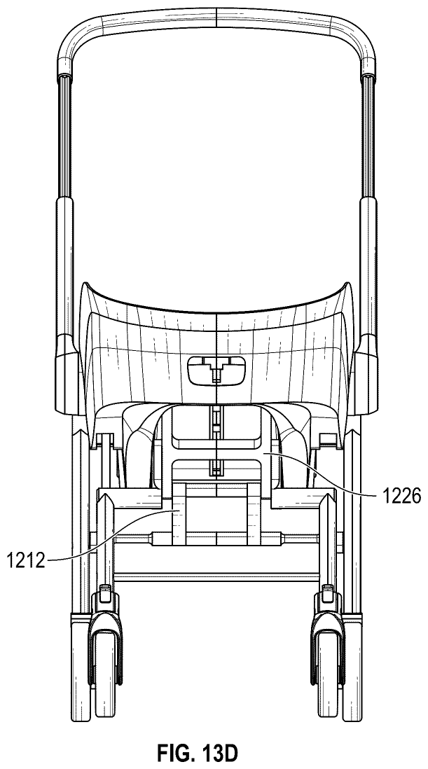

FIG. 12 illustrates a perspective view of a car seat and stroller combination system 1200 according to another embodiment of the present disclosure. FIGS. 13A-13D illustrate two side views, a back view, and front view, respectively of the car seat and stroller combination system 1200 in an unfolded state. The following description is provided with reference to FIGS. 12 and 13A-13D. The car seat and stroller combination system 1200 includes a car seat shell 1202 fixedly attached to a leg assembly. The car seat shell 1202 includes a telescoping handle 1204 attached to the car seat shell 1202 at a connection point 1224 along each side of the car seat shell 1202. The telescoping handle 1204 can be used to maneuver the car seat and stroller combination system 1200. The telescoping handle 1204 is movable radially and can be placed in one or more positions along a radial path. The leg assembly may include a pair of front legs 1214 and a pair of back legs 1206. Each of the front legs 1214 has a swivelable front wheel 1210 attached to a first end of the front leg 1214. An opposing second end of each of the front legs 1214 is attached to a lower side of the car seat shell 1202 at a corresponding front leg attachment point. Each of the back/rear legs 1206 has a back wheel 1208 attached to a first end of the back leg 1206. An opposing end of each of the back legs 1208 is attached to the lower side of the car seat shell 1202 at a corresponding back leg attachment point. In an embodiment, the front wheels 1210 are smaller in diameter than the back wheels 1208. In another embodiment, the back wheels 1208 are fixed and not swivelable. In yet another embodiment, the various components of the car seat and stroller combination system 1200 can be manufactured using materials that include one or more of plastic, metal, rubber, polycarbonate, or the like.

The car seat and stroller combination system 1200 further includes a pair of first cross-link members 1212 extends between a second cross-link member 1226 and back legs 1206. A first transverse member 1216 extends horizontally between the two back legs 1206 and connects the two back legs 1206 to each other. Each cross-member of the first pair of cross-link members 1212 connects to the first transverse member 1216 at one end. The other end of the first pair of cross-link members 1212 are connected to an end of the pair of second cross-link members 1226. The other end of the second pair of cross-link members 1226 are connected to a back-side surface of the car seat shell 1202, as illustrated in FIG. 13D. A second transverse member 1218 extends between the pair of front legs 1214 connecting both the front legs 1214 to each other.

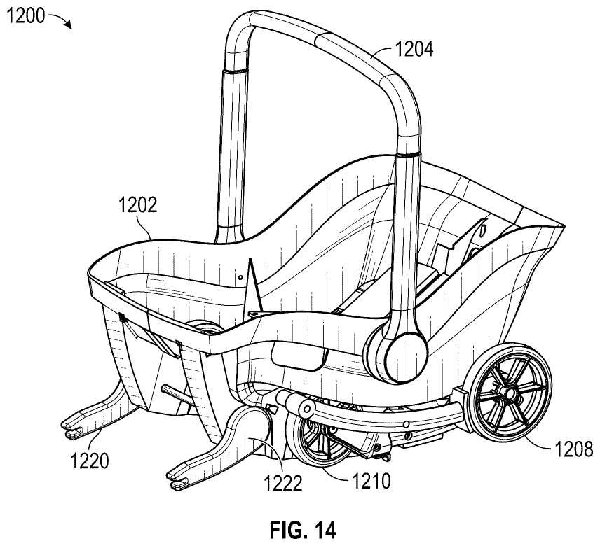

The car seat and stroller combination system 1200 further includes a latch release handle located along a front surface of the car seat shell 1202. Operation of the latch release handle enables the leg assembly to be folded in an accordion style as explained in relation to the other embodiments described above. The car seat shell 1202 further includes a first recessed region along a first side and a second recessed region located along a second opposing side of the car seat shell 1202. The first recessed region and the second recessed region are configured to receive portions of the front wheels 1210 when the car seat and stroller combination system 1200 is placed in a folded configuration. Further, the connection point 1224 where the telescoping handle 1204 is attached to the car seat shell 1202 is not connected to any portion of the front legs 1214 or the back legs 1206. The connection point 1224 is located higher than any of the components of the leg assembly. The car seat and stroller combination system 1200 further includes a pair of connection brackets 1220. Each connection bracket 1220 is attached to a respective side of the car seat shell 1202 closer to the back legs 1206. The connection brackets 1220 are attached to the car seat shell 1202 at a respective connection point 1222. The connection point 1222 acts as a pivot and each of the connection brackets 1222 are rotatable around the pivot/connection point 1222. When not in use, the connection brackets 1222 may be placed in a first or folded position as illustrated in FIG. 13A. When the car seat and stroller combination system 1200 is to be placed in a vehicle and connected to an anchor within the vehicle, the connection brackets 1222 can be placed in a second or unfolded state, as illustrated in FIG. 14. The rest of the construction details for the car seat and stroller combination system 1200 is similar to the car seat and stroller combination system 10 or 100 described above.

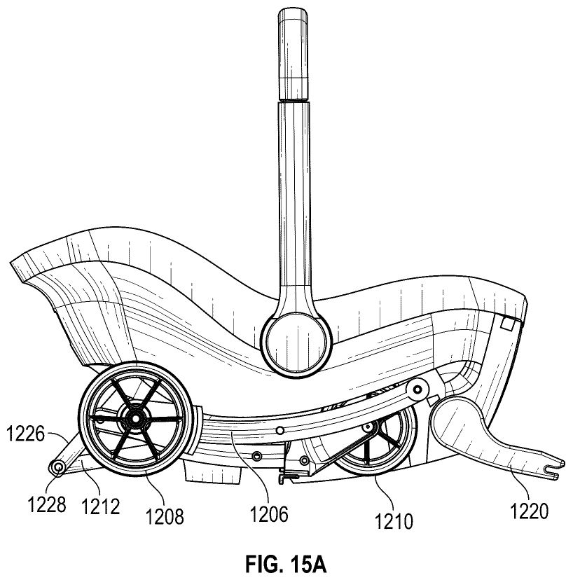

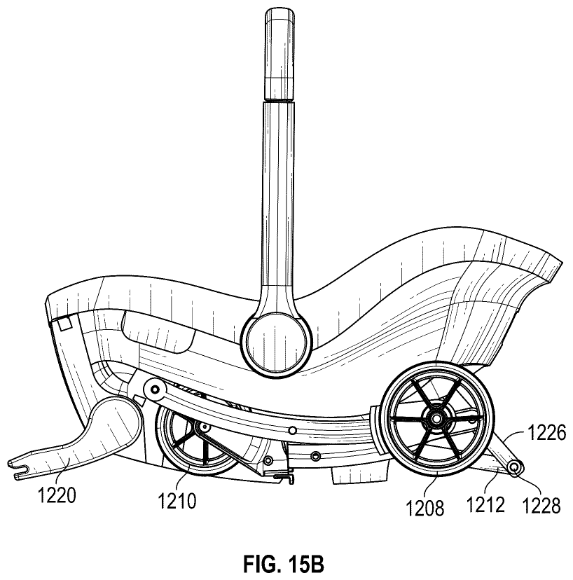

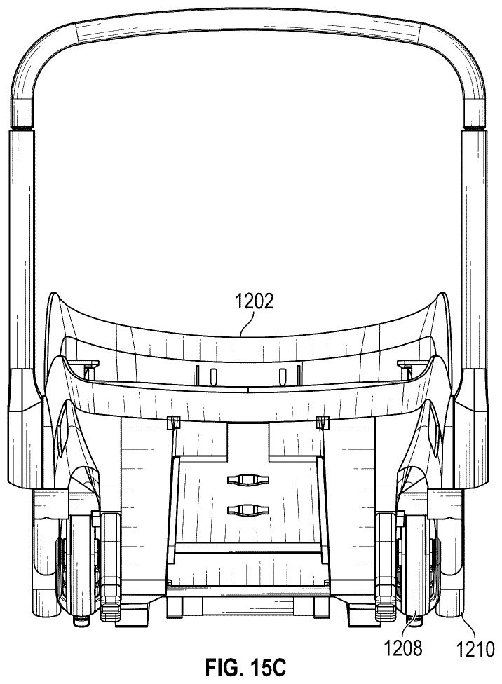

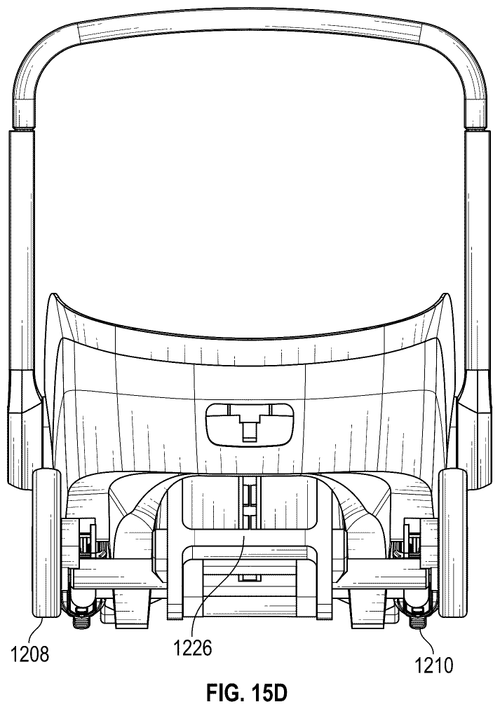

FIGS. 14 and 15A-15D show various views of the car seat and stroller combination system 1200 in a folded state according to an embodiment of the present disclosure. As explained above with reference to the car seat and stroller combination system 10, the leg assembly of the car seat and stroller combination system 1200 can be folded in an accordion style configuration when the car seat and stroller combination system 1200 is to be stored or placed in a vehicle. In the folded state, the pair of back legs 1206 and the pair of front legs 1214 are rotated in opposite directions. As a result, the pair of back wheels 1208 fold toward the front side and the front wheels 1210 fold toward the back side of the car seat shell 1202. As illustrated in FIGS. 14, 15A, and 15B, in the folded state, the front wheels 1210 are partially disposed with the recesses regions that are present on each side of the car seat shell 1202. At least portion of the back legs 1206 overlies the front wheels 1210 on either side of the car seat shell 1202. Further in the folded state, the pair of front wheels are located behind the connection brackets 1220 as illustrated in FIGS. 15A and 15B. The connection brackets 1220 can be rotated to their open/unfolded state toward a back side of the car seat shell 1202 for connection to a vehicle anchor point when the car seat and stroller combination system 1200 is in the folded state. The first pair of cross-link members 1212 are connected to a second pair of cross-link members 1226 at a connection point 1228, as illustrated in FIG. 15A. When the car seat and stroller combination system 1200 is folded the first pair of cross-link members 1212 move in a first direction and the second pair of cross-link members move in a second direction that is different from the first direction around the connection point 1228. In the folded state, a portion of the pair of first cross link members 1212 and a portion of the second pair of cross-link member 1226 protrudes behind the pair of back wheels 1208 and toward a front side of the car seat shell 1202, as illustrate in FIG. 15A. The rest of the details of the car seat and stroller combination system 1200 in the folded state is similar to the description provided above in relation to the car seat and stroller combination system 10.

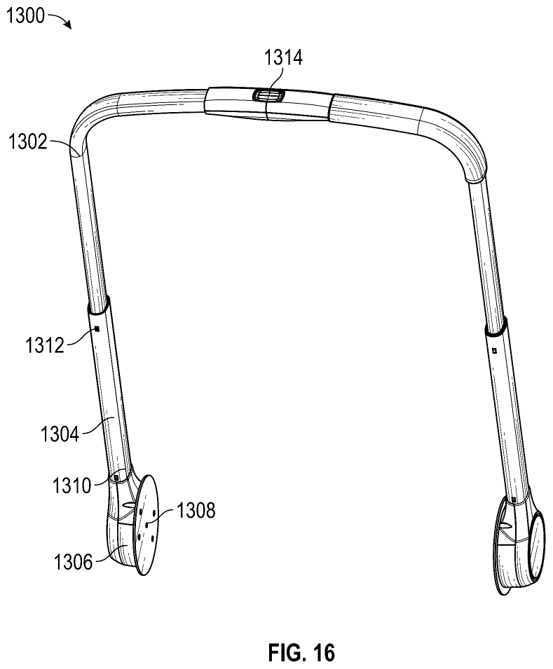

FIG. 16 illustrates a handle assembly 1300 for a stroller according to an embodiment of the present disclosure. The handle assembly 1300 may be used in any of the car seat and stroller combination systems described above or with any other stroller. The handle assembly 1300 includes a first member 1302, which can also be referred to as the inner tube member. The handle assembly also includes a second member 1304, which can also be referred to as the outer tube member. The first member 1302 is slidable within the second member 1304. The first member 1302 includes a button assembly that includes a button 1314. The button 1314 has multiple operation modes. For example, the button 1314 may be operated to activate the handle rotate mode and the handle telescoping mode. Thus, the same button 1314 can be activated to enable multiple modes for the operation of the handle assembly 1300. The handle assembly 1300 also includes hub assembly 1306. The hub assembly 1306 includes a connection plate 1308. In an embodiment, the connection plate 1308 may be attached to the car seat shell 1202 described above at the connection point 1224. The second member 1304 is coupled to the hub assembly 1306 at a first end of the second member 1304. The second opposing end of the second member 1304 is coupled to the first member 1302. The second member 1304 includes a first opening 1310 at a location near the first end and proximate to the hub assembly 1306. The second member 1304 also includes a second opening 1312 at a location near the second end. The first member 1302 includes a spring-loaded tab that engages with the first opening 1310 when the handle assembly 1300 is in a retracted state. The tab engages with the second opening 13123 when the handle assembly 1300 is in an extended state.

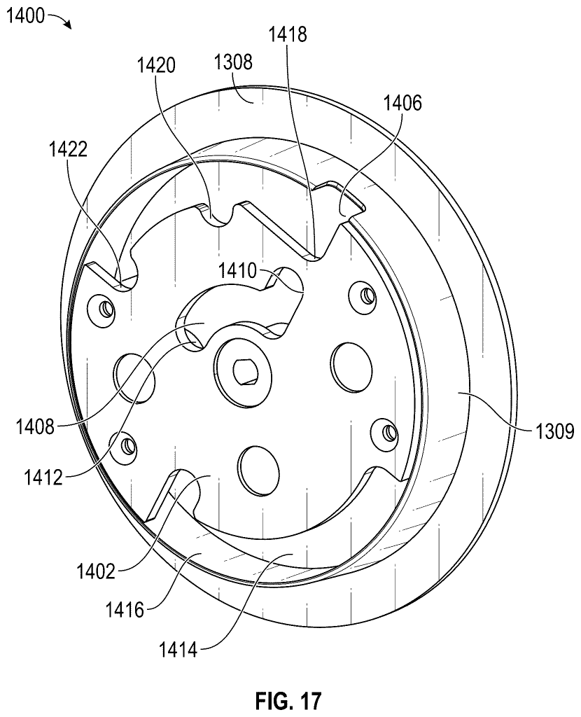

FIG. 17 illustrates a view of a portion 1400 of the hub assembly 1306 according to an embodiment of the present disclosure. The hub assembly 1306 includes a connection plate 1308 that is used to connect the hub assembly 1306 to the car seat shell 1202. The connection plate may be circular in shape and has a first surface and an opposing second surface. The first surface of the connection plate 1308 mates with a corresponding surface on the car seat shell 1202. The second surface of the connection plate 1308 includes a raised ring structure 1309. The raised ring structure 1309 is disposed around a periphery of the connection plate 1308. The raised ring structure 1309 includes a cut-out portion 1406. The hub assembly 1306 also includes a master plate 1402. The master plate 1402 is coupled to the connection plate 1308 at a center of the connection plate 1308. The master plate 1402 is disposed such that the raise ring structure 1309 completely surrounds the master plate 1402.

The master plate 1402 is fixed and does not move when the handle assembly 1300 is rotated into different positions, is in the telescoped-out state, or is in the retracted state. The master plate 1200 has multiple recessed areas around a periphery of the master plate 1402. The master plate 1402 includes a first recessed region 1418. The first recessed region 1418 aligns with the cut-out portion 1406 of the raised ring structure 1309. Since both, the master plate 1402 and the raised ring structure 1309 do not move when the handle assembly 1300 is rotated, telescoped out or retracted in, the first recessed region 1418 is always aligned with the cut-out portion 1406. The master plate 1402 includes a second recessed region 1420 that is adjacent to the first recessed region 1418. In an embodiment, the second recessed region 1420 is “U” shaped. The master plate 1402 includes a third recessed region 1422 that is adjacent to the second recessed region 1420. In an embodiment, the third recessed region 1422 is also “U” shaped, but has one leg of the “U” shape longer than the other leg. The longer portion of the “U” shape of the third recessed region 1422 acts as a mechanical hard stop and the handle assembly 1300 cannot be rotated beyond that point. The master plate 1402 includes a fourth recessed region 1416 that is located on an opposite end from the first recessed region 1418. In an embodiment, the fourth recessed region 1416 is also “U” shaped, but has one leg of the “U” shape longer than the other leg. The longer portion of the “U” shape of the fourth recessed region 1416 acts as a mechanical hard stop and the handle assembly 1300 cannot be rotated beyond that point. The master plate 1402 includes a fifth recessed region 1414 that is separated by a distance from the fourth recessed region 1416. The fifth recessed region 1414 also acts as a mechanical hard stop. The handle assembly may rotate between the fourth recessed region 1416 and the fifth recessed region 1414, as will be explained below. The first recessed region 1418, the second recessed region 1420, the third recessed region 1422, the fourth recessed region 1416, and the fifth recessed region 1414 enable the handle assembly 1300 to be rotated in three different positions as explained below.

The master plate 1402 further includes a slot 1408. The slot 1408 is shaped to have a first region 1410 and a second region 1412. The first region 1410 acts as a hard stop and is used to transition between the rotating mode, the telescoped out, and the retracted modes of the handle assembly 1300. The second region 1412 allows the handle assembly 1300 to rotate and as part of the rotation, the handle assembly can traverse from one end of the second region 1412 to the other end of the second region 1412. The function of the master plate 1402 is described below in detail.

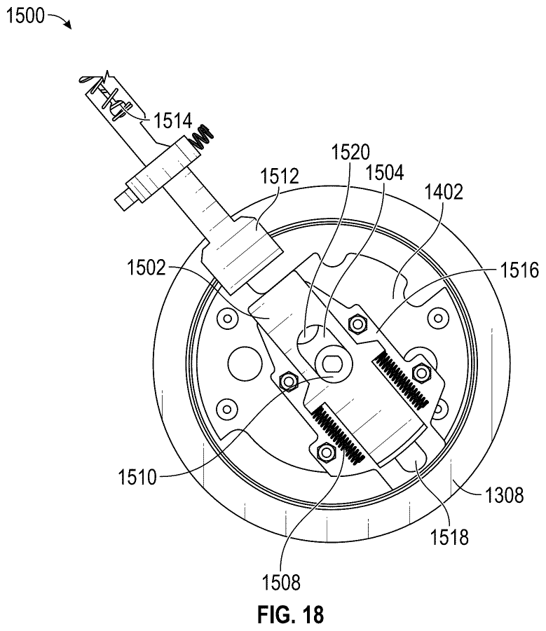

FIG. 18 illustrates a partial view 1500 of the hub assembly 1306 according to an embodiment of the present disclosure. This view illustrates the components located at the different side of the master plate 1402 than what is illustrated in FIG. 17. The hub assembly 1306 further includes a handle lock pin assembly 1502 coupled to the master plate 1402 and a handle retainer plate 1516. The handle lock pin assembly 1502 includes an elongated slot 1504. A pair of biasing springs 1508 are coupled to the handle lock pin assembly 1502 and disposed along two opposing sides of the handle lock pin assembly 1502. The springs 1508 are connected to the handle retainer plate 1516. The springs 1508 continually exert an upward force that keeps the handle lock pin assembly biased in first position in which a center opening 1510 of the connection plate 1308 is disposed at a first end of the slot 1504. The handle retainer plate 1516 includes a first elongated slot 1518 and a second circular opening 1520. The first elongated slot 1518 and the second circular opening 1520 are located at opposing ends of the handle retainer plate 1516. The handle retainer plate 1516 is fixed immovably to the master plate 1502. When pressure is exerted on the handle lock pin assembly 1502, the springs 1508 are compressed thereby moving the handle lock pin assembly 1502 in a downward direction. This causes the center opening 1510 to be located from the first end of the slot 1504 to the second end of the slot 1504.

The handle assembly 1300 further includes a handle mode plate 1512 that is connected mechanically to the button 1314 of the handle assembly 1300. When the button 1314 is operated, the handle mode plate 1512 is translated toward the handle lock pin assembly 1502. In an embodiment, the handle mode plate 1512 exerts pressure on the handle lock pin assembly 1502 causing the handle lock pin assembly 1502 to move in a downward direction. The handle mode plate 1512 is coupled with a spring 1514. When the button 1314 is pressed, it causes the spring 1514 to compress thereby moving the handle mode plate 1512 in a downward direction and mating with the handle lock pin assembly 1502. In the default operation mode of the handle assembly 1300, the handle mode plate 1512 is not in contact with the handle lock pin assembly 1502 due to the spring 1514 exerting an upward force on the handle mode plate 1512.

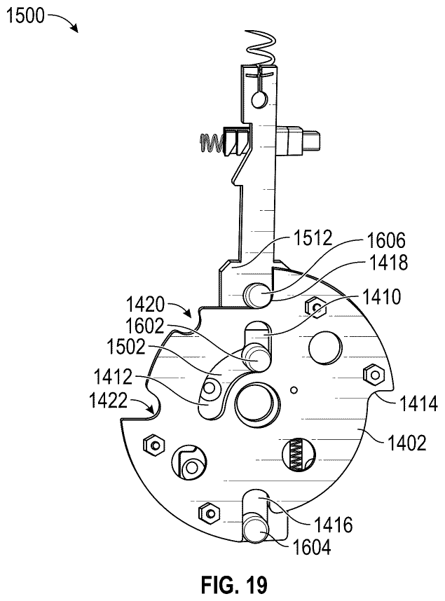

FIG. 19 illustrates a partial view of the portion 1500 as seen from the other side of the portion 1500 according to an embodiment of the present disclosure. The handle mode plate 1512 includes a handle mode pin 1606. The handle mode pin 1606 is configured to traverse between the first recessed region 1418, the second recessed region 1420, and the third recessed region 1422. The handle lock pin assembly 1502 includes a first handle lock pin 1602 and a second handle lock pin 1604. The first handle lock pin engages with/in the slot 1408 and can traverse between the first region 1410 and the second region 1412. The second handle pin lock 1604 can traverse between the fourth recessed region 1416 and the fifth recessed region 1414. In an embodiment, the first handle lock pin 1602, the second handle lock pin 1604, and the handle mode pin 1606 are configured to move in the same direction when the handle assembly 1300 is rotated between the three positions. The movement paths of the first handle lock pin 1602, the second handle lock pin 1604, and the handle mode pin 1606 are radial and concentric to each other.

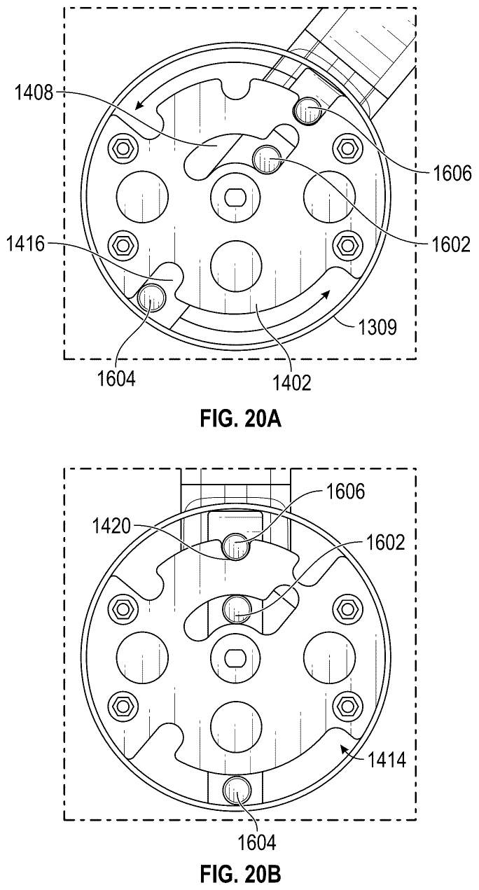

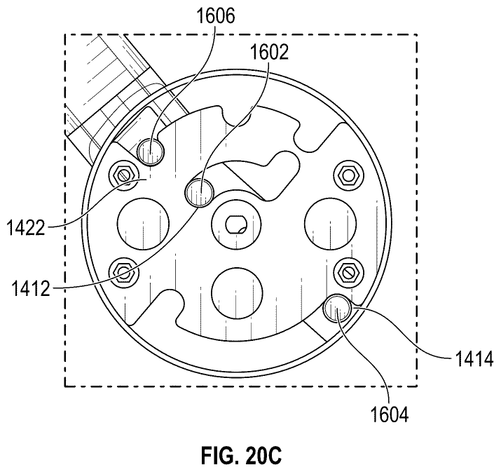

FIGS. 20A-20C illustrate the function of the handle assembly 1300 when the handle assembly is rotated between three positions according to an embodiment of the present disclosure. Consider that the handle assembly 1300 is in a first position in which the handle assembly 1300 is in a retracted state, as illustrated in FIG. 20A. In order to initiate rotation of the handle assembly, the button 1314 may be operated. Operation of the button may cause the handle mode plate 1512 to move in an upward direction causing the handle mode pin 1606 to move in an upward direction and disengage from the first recessed region 1418. The operation of the button 1314 also causes the first handle lock pin 1602 to move out of the first region 1410 and rest at one end of the slot 1408. Concurrently, the second handle lock pin 1604 moves out of the fourth recessed region 1416 and is now free to traverse to the fifth recessed region 1414. This initiates the rotating motion for the handle assembly 1300.

FIG. 20B illustrates the handle assembly 1300 in a second position during the rotation according to an embodiment of the present disclosure. In the second position, the handle mode pin 1606 engages within the second recessed region 1420, the first handle lock pin 1602 is now in a second position within the slot 1408 between the first region 1410 and the second region 1412. The second handle lock pin 1604 is also at a second position between the fourth recessed region 1416 and the fifth recessed region 1414. FIG. 20C illustrates the handle assembly 1300 in a third position during the rotation according to an embodiment of the present disclosure. In the third position, the handle mode pin 1606 engages within the third recessed region 1422, the first handle lock pin 1602 engages with the third recesses region 1422, and the second handle lock pin 1604 engages with the fifth recessed region 1414. The third position marks the end of the travel for the handle mode pin 1606, the first handle lock pin, and the second handle lock pin 1604 as all of them encounter a hard stop in this position. The handle assembly 1300 cannot be rotated any further than this position. In order to rotate the handle assembly 1300 back to the first position, a reverse process may be followed and all of the handle mode pin 1606, the first handle lock pin, and the second handle lock pin 1604 will move in an opposite direction than the one shown in FIGS. 20A-20C.

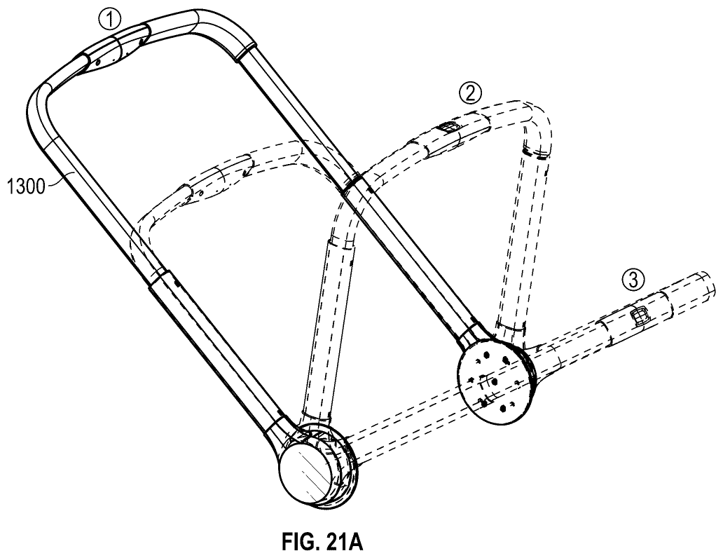

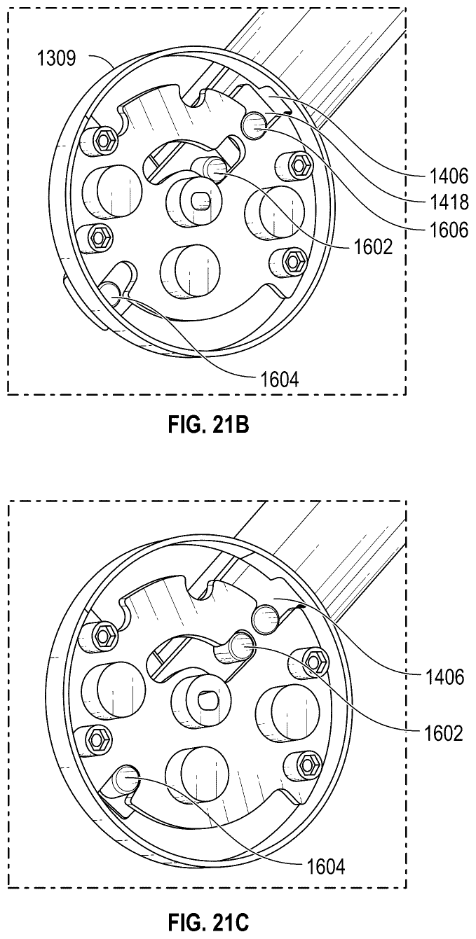

FIGS. 21A-21C illustrate the operation of the handle assembly 1300 when the handle assembly 1300 is telescoped out or retracted according to an embodiment of the present disclosure. When the handle assembly is telescoped out, the stroller may be operated in its default mode of being pushed. In order to rotate the handle assembly 1300, the handle assembly 1300 must first be placed in the retracted state and then rotated as describe above. The button 1314 is a multi-function button that can be placed in two or more positions in order to telescope out the handle assembly 1300, retract in the handle assembly 1300, and to rotate the handle assembly 1300. As illustrated in FIG. 21A, the handle assembly 1300 can be placed in three positions in the rotational mode. However, the handle assembly can be telescoped out and retracted only when the handle assembly 1300 is in the first position. In the second and the third position, the handle assembly can only be rotated—not telescoped out or retracted in. FIG. 21B illustrates a situation in which the handle assembly 1300 is in a retracted position. This corresponds to position 1 in FIG. 21A. In the retracted position, the handle mode pin 1606 is engaged with the first recessed region 1418. This prevents the handle mode pin 1606 from moving, thus effectively preventing the handle assembly from being rotated. In order to rotate the handle assembly, the button 1314 can be operated that releases the handle mode pin 1606 from the first recessed region 1418 to allow the handle assembly to rotate as described above. In the retracted-in position, the handle lock pin 1602 is resting within the slot 1408, and the second handle lock pin 1604 is disengaged from the fourth recessed region 1416. As can be seen, the cut-out 1406 in the raised ring structure 1309 is aligned with the first recessed region 1418.

In order to place the handle assembly 1300 in the telescoped-out position, the button 1314 may be operated a second time. This causes the handle mode plate 1512 to move upward thereby causing the handle mode pin 1606 to also move upward. Since the cut-out 1406 in the raised ring structure 1309 is aligned with the first recessed region 1418, it allows the handle mode pin 1606 to move beyond the raise ring structure 1309. This action also releases the pressure on the handle lock pin assembly 1502 and causes the springs 1608 to lift up the handle lock pin 1602 and the second handle lock pin 1604. This results in the first handle lock pin 1602 engaging within the first region 1410 and the second handle lock pin 1604 engaging with the fourth recessed region 1416, as illustrated in FIG. 21C. This prevents both the first handle lock pin 1602 and the second handle lock pin 1604 from rotating thus locking the handle assembly 1300 in the telescoped-out position. In an embodiment, the telescoped-out position may be used when the stroller is to be pushed around as opposed to being in the carrying or storage positions.

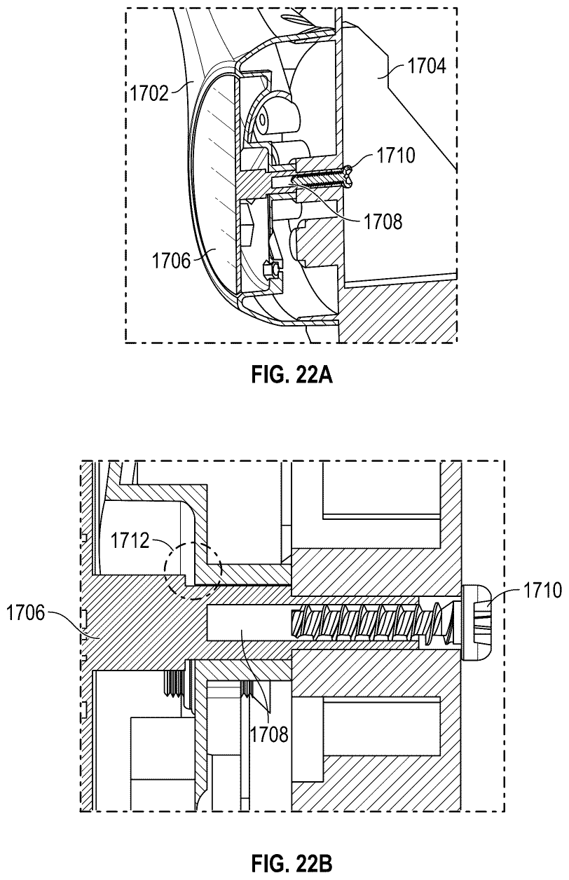

FIGS. 22A and 22B illustrate a mechanism that may be used in the car seat and stroller combination system 1200 to ensure that the logo plate remains stationary at all times and does not rotate along with the handle assembly 1300 of the car seat and stroller combination system 1200, according to an embodiment of the present disclosure. FIG. 22A and FIG. 22B illustrate cross-sectional views of a portion of the hub assembly 1306 according to an embodiment of the present disclosure. A portion of the outer tube member 1702 is attached to a portion of the car seat shell 1704. A logo member 1706 is coupled to the outer tube member 1702. The logo member has a connection member 1708 that extends into the car seat shell 1704 and connected to the car seat shell via a fastener 1710. In an embodiment, the connection member 1708 extends through the center opening 1510 of the connection plate 1402. The center opening 1510 has flattened top and bottom and curved sides. This locks the logo member 1706 in place. Further, there is a gap/clearance 1712 between logo member 1706 and the end of the outer tube member 1702. This allows the outer tube member 1702 to rotate around the logo member 1706 without the logo member 1706 rotating. In this manner the logo member 1706 always stays in the same orientation regardless of the position of the handle assembly 1300.

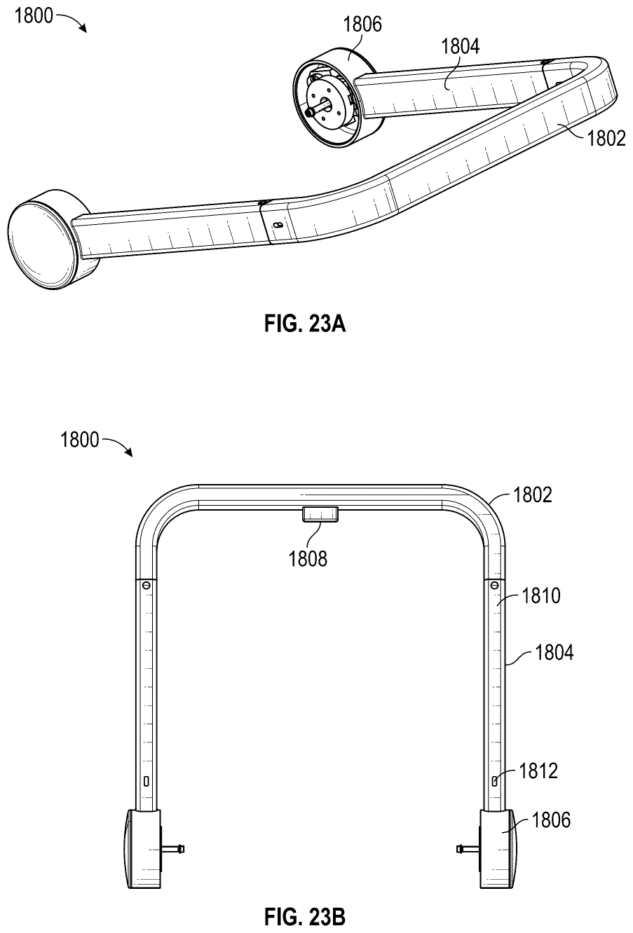

FIGS. 23A and 23B illustrate a handle assembly 1800 of a car seat and stroller combination system according to another embodiment of the present disclosure. The handle assembly 1800 includes a first member 1802 and two second members 1804 that are attached to either end of the first member 1802. Each second member 1804 is coupled to a hub assembly 1806. Each hub assembly 1806 is connected to a side of the car seat shell (e.g., car seat shell 1202 described above). The first member 1802 may include a button 1808 that is operable to maneuver the handle assembly 1800. For example, the button 1808 is operable to extend or retract the handle assembly 1800 and also to rotate the handle assembly 1800. Thus, the same button 1808 is used for enabling multiple functions of the handle assembly 1800. Each of the second members 1804 includes a first opening 1810 located close to a first end of the second member 1804 and a second opening 1812 located toward an opposing second end of the second member 1804. The first opening 1810 and the second opening 1812 are used to lock the first member 1802 with respect to the second member 1804 when the handle assembly is retracted in or telescoped out.

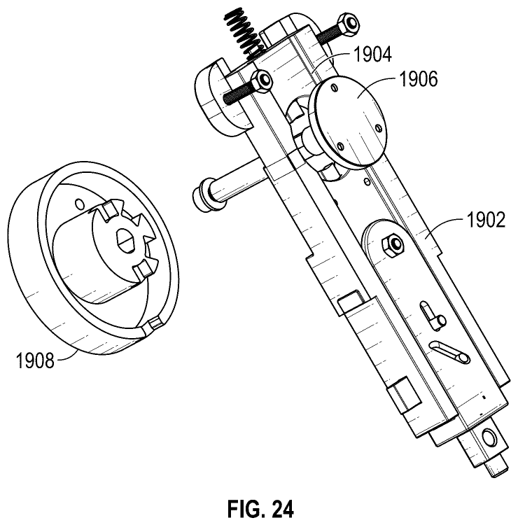

FIG. 24 illustrates a partial view of the hub assembly 1806 and the internal components disposed in the second member 1804 according to an embodiment of the present disclosure. The second member 1804 enclosed a slider assembly 1902. The hub assembly 1806 includes a primary lock assembly 1904 that is coupled to a cover of the hub assembly. The hub assembly 1806 further includes a locking pin 1906 that couples a logo member to the car seat shell. The hub assembly 1806 also includes a guide lock 1908. The slider assembly 1902, the primary lock 1904, and the guide lock 1908 work together to enable the handle assembly 1800 to rotate in multiple positions and allow the handle assembly 1800 to be placed in a telescoped-out position and a telescoped-in position.

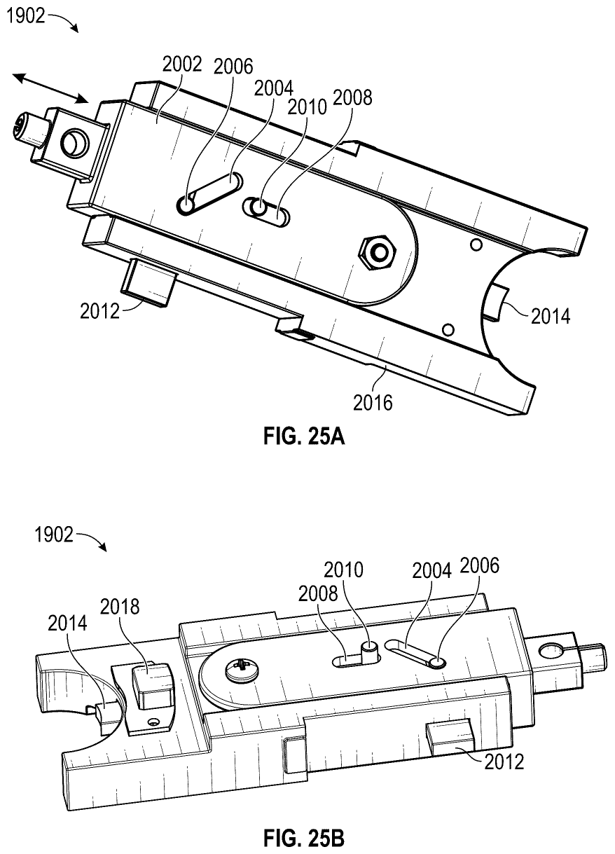

FIGS. 25A and 25B illustrate details of the slider assembly 1902 according to an embodiment of the present disclosure. The slider assembly 1902 includes a handle slider 2002. The handle slider 2002 is connected to the button 1808 via a cable. The button 1808 can be operated to move the handle slider 2002 in a first direction toward the button 1808 and a second direction away from the button 1808, as indicated by the dual-sided arrow in FIG. 25A. The handle slider 2002 is configured to slide over a handle slider housing 2016. The handle slider 2002 includes a first slot 2004 and a second slot 2008. The first slot 2004 at least partially overlaps a horizontal slot (not shown) in the handle slider housing 2016. In an embodiment, the first slot 2004 is slanted with respect to a horizontal axis. The handle slider housing 2016 includes a first pin 2006 that engages with the first slot 2004. The handle slider 2002 includes a second slot 2008 and the handle slider housing 2016 includes a second fixed pin 2010 that engages with the second slot 2008. The first pin 2006 is moveable between a first position and a second position. When the handle slider 2002 is in the first position as shown in FIG. 25A, the first pin 2006 is at a first end of the first slot 2004. When the handle slider 2002 is in a second position, the first pin 2006 is at a second opposing end of the first slot 2004. The first pin 2006 is connected to a telescope lock 2012. The first pin 2006 is can transverse in a horizontal direction and when the first pin travels in the horizontal direction it either engages the telescope lock 2012 or disengages the telescope lock 2012 from one of the first opening 1810 or the second opening 1812. The slider assembly 1902 further includes a secondary lock 2014 that is configured to engage with one or more features on the guide lock 1908. The slider assembly 1902 further includes a telescope extension lock 2018. The telescope extension lock 2018 is configured to engage with one or more features on the guide lock 1908.

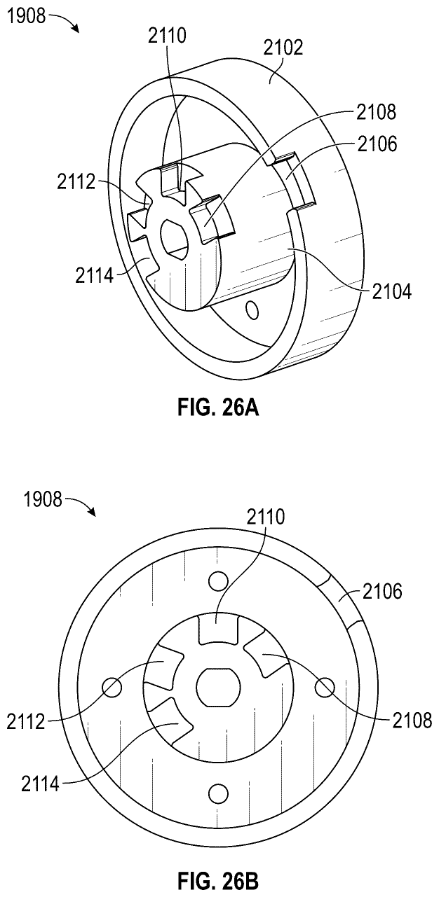

FIGS. 26A and 26B illustrate details of the guide lock 1908 according to an embodiment of the present disclosure. The guide lock 1908 includes a housing 2102. The housing 2102 includes a cut-out 2106 located on a periphery of the housing 2102. The guide lock 1908 further includes a raised structure 2104 disposed within the housing 2102 and at a center of the housing 2102. The raised structure 2104 has multiple recessed regions integrated into the raised structure 2104. The multiple recessed regions include a first recessed region 2108, a second recessed region 2110, a third recessed region 2112, and fourth recessed region 2114. The cut-out 2106 is aligned with the first recessed region 2108. Since the guide lock 1908 is fixed and does not move or rotate, the cut-out 2106 is always aligned with the first recessed region 2108 in all modes of operation of the handle assembly 1800. In an embodiment, the first recessed region 2108 is associated with the telescoping feature of the handle assembly 1800, the second recessed region 2110 is associated with the carry feature of the handle assembly 1800, the third recessed region 2112 is associated with a store feature of the handle assembly 1800, and the fourth recessed region 2114 is associated with a telescope lock feature of the handle assembly 1800.

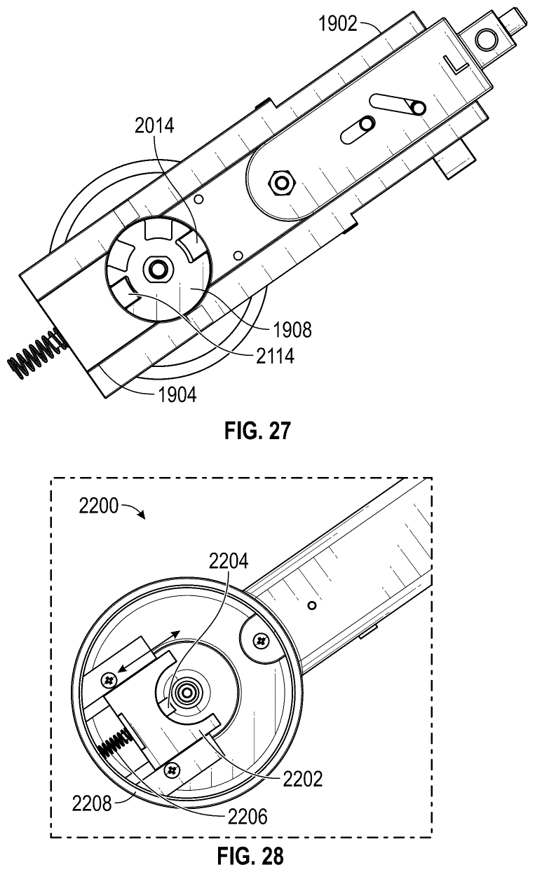

FIG. 27 illustrates a scenario showing how the slider assembly 1902, the guide lock 1908, and the primary lock 1904 are positioned with respect to each other according to an embodiment of the present disclosure. As shown in FIG. 27, the secondary lock 2014 of the slider assembly 1902 is engaged with a recessed region of the guide lock 1908. The primary lock 1904 is engaged with the fourth recessed region 2114 of the guide lock 1908. The primary lock 1904 can be moved between the first recessed region 2108, the second recessed region 2110, and the third recessed region 2112 to effect the rotating motion for the handle assembly 1800. The primary lock 1904 cannot be moved beyond the third recessed region 2112. In other words, the primary lock 1904 can never be engaged with the fourth recessed region 2114 of the guide lock 1908.

FIG. 28 illustrates a view of a hub cover assembly 2200 of the handle assembly 1800 according to an embodiment of the present disclosure. The hub cover assembly 2220 houses the primary lock 1904. The primary lock 1904 includes a planar member 2202 and a lock tab 2204 attached to the planar member 2202. A spring 2206 is attached to the planar member 2202 and is disposed between the planar member and a housing 2208 of the hub cover assembly. The spring 2206 exerts a pressure on the planar member to keep the lock tab 2204 engaged with the guide block 1908. The operation of the button 1808, in one instance, can move the slider assembly 1902 such the slider assembly 1902 exerts a downward pressure on the planar member 2202.

This causes the spring 2206 to compress and disengages the lock tab 2204 from the guide lock 1908. The planar member 2202 is attached fixedly to the hub cover 2208 by fasteners.

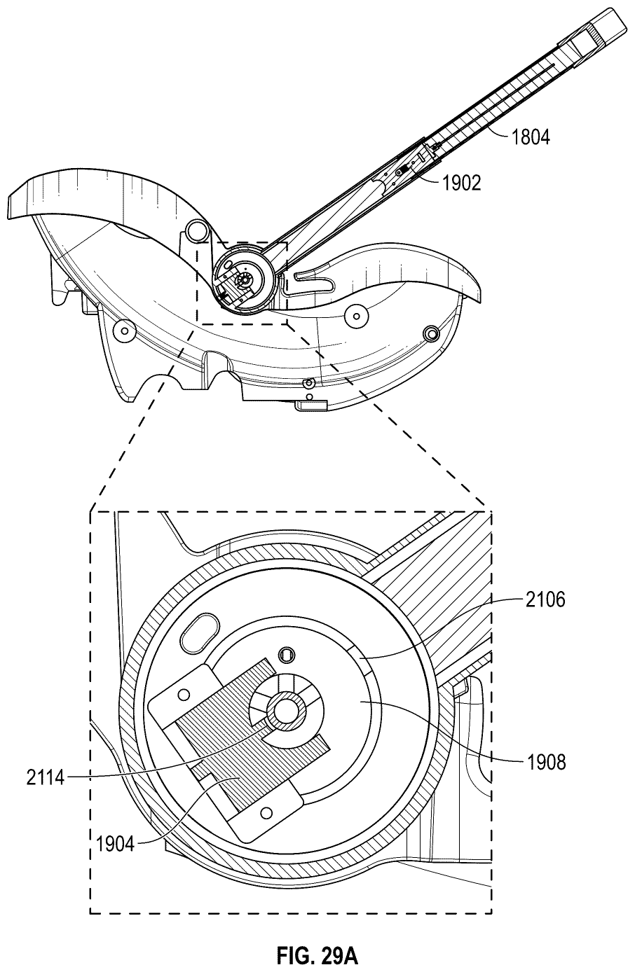

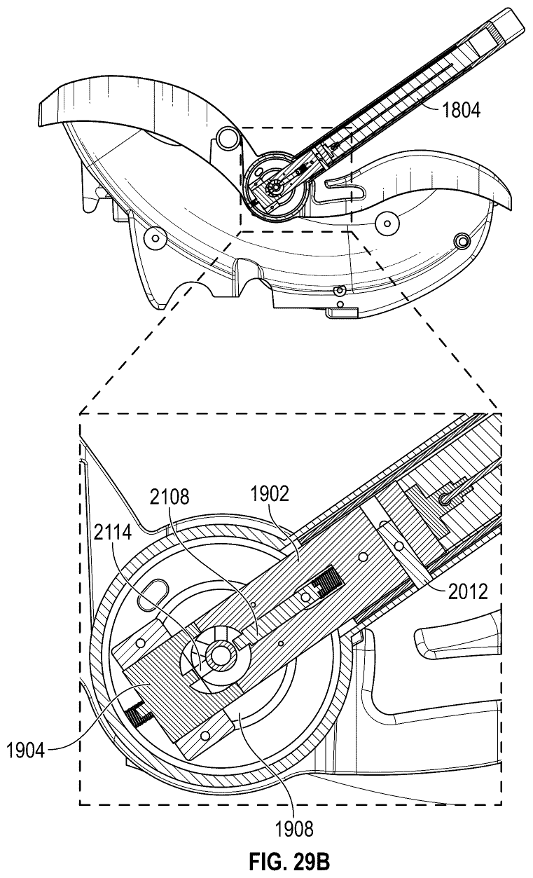

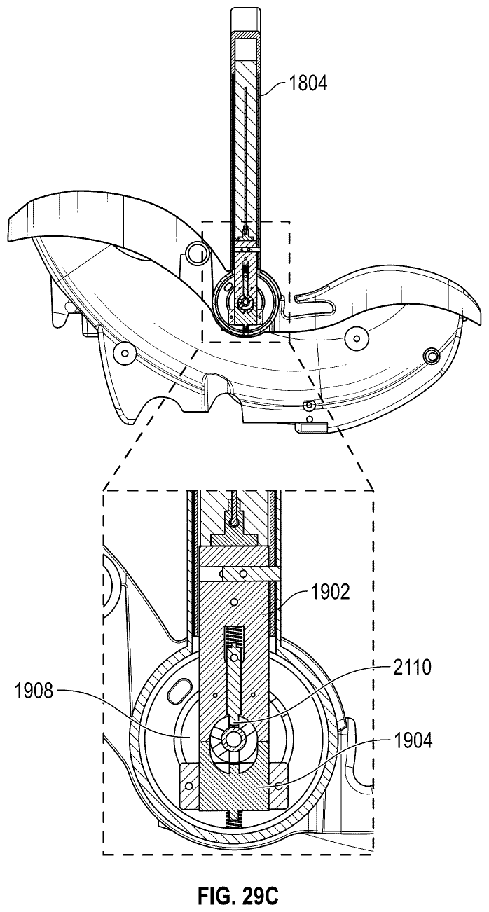

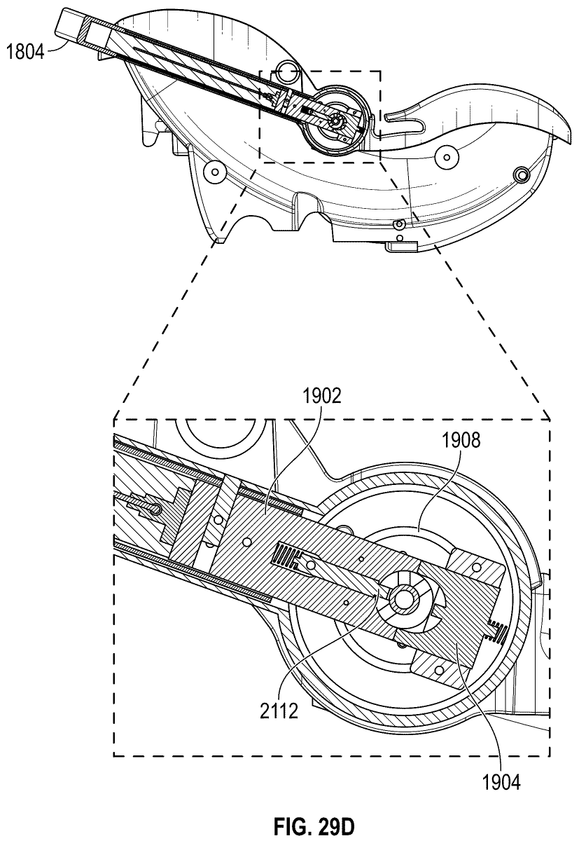

FIGS. 29A-29D illustrate the operation of the handle assembly 1800 in four different modes according to an embodiment of the present disclosure. FIG. 29A illustrates a first mode of operation of the handle assembly according to an embodiment of the present disclosure. The first mode can also be referred to as the “stroller mode.” In the stroller mode the handle assembly 1800 is extended or telescoped out and cannot be rotated since the hub rotation lock is engaged. In this mode, the slider assembly 1902 is retracted into the second member 1804 and is not in mechanical contact with either the guide lock 1908 or the primary lock 1904. In this mode, the tab of the primary lock 1904 is engaged with the fourth recessed region 2114 of the guide lock 1908. In this mode, the handle assembly cannot be rotated due to primary lock 1904 being engaged with the fourth recessed region 2114. FIG. 29B illustrates a second mode in which the handle assembly 1800 is retracted and the second member 1804 slides into the first member 1802 according to an embodiment of the present disclosure. The second mode may also be referred to as the “car seat mode.” This mode can be enabled by activating the lock 1808 once. In this mode, the rotation of the handle assembly is enabled, and telescoping mode is also enabled. In this mode, the slider assembly 1902 comes in physical contact with the primary lock 1904. This causes the lock tab 2204 of the primary lock 1904 to disengage from the fourth recessed region 2114. Concurrently, the secondary lock 2014 of the slider assembly 1902 engages with the first recessed region 2108 of the guide lock 1908. The handle assembly 1800 is now in a condition to be rotated. In this mode, the telescope lock 2012 engages with the second opening 1812, locking the second member 1804 in a retracted position.

FIG. 29C illustrates a third mode of operation of the handle assembly 1800 according to an embodiment of the present disclosure. In this mode, the telescopic operation of the handle assembly 1800 is locked such that the handle assembly cannot be telescoped out. The third mode may also be referred to as the “carrying mode.” In order to rotate the handle assembly 1800, the button 1808 may be activated (i.e., pushed) again. Activation of the button causes the secondary lock 2014 of the slider assembly 1902 to disengage from the first recessed region 2108. The second member 1804 then can be rotated in a first direction. When the secondary lock 2014 is aligned with the second recessed region 2110 of the guide lock 1908, the secondary lock 2014 engages with the second recessed region 2110 causing the second member 1804 to be held in the second position, as illustrated in FIG. 29C. FIG. 29D illustrates a fourth mode of operation of the handle assembly 1800 according to an embodiment of the present disclosure. The fourth moder may also be referred to as the “storage mode.” In the fourth mode, the second member 1804 is rotated to a fourth position. When the handle assembly is in the third mode, the button 1808 can be activated. Activation of the button 1808 causes the secondary lock 2014 to disengage from the second recessed region 2110. The second member 1804 can now be rotated again in the first direction until the secondary lock 2014 engages with the third recessed region 2112. In order to bring the handle assembly back to the first position as illustrated in FIG. 29A, the same process explained above can be repeated and the second member 1804 can be rotated in a second direction that is opposite of the first direction. In this manner, the same button 1808 can be used to activate the extension and retraction of the handle assembly and for activating the rotation modes for the handle assembly.

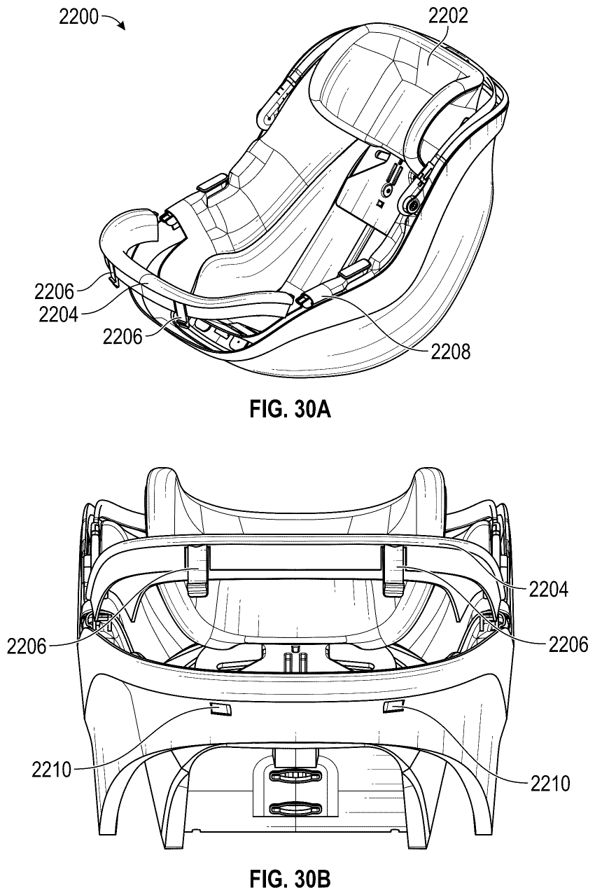

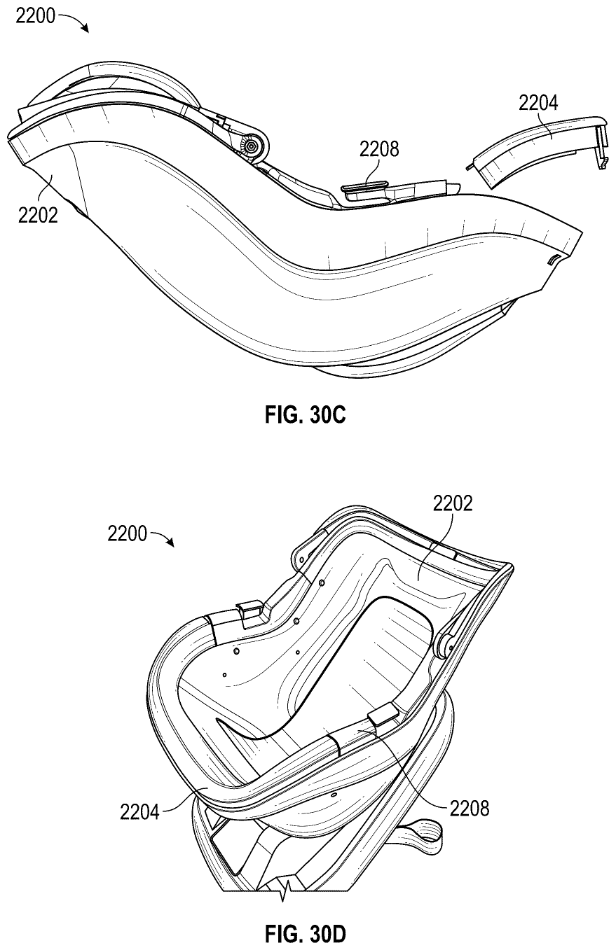

FIGS. 30A-30D illustrates various views of a car seat shell assembly 2200 according to another embodiment of the present disclosure. The car seat shell assembly 2200 includes a movable lip/rim that can be used to attach soft goods to the car seat shell 2202. In this context, “soft goods” refer to the fabric, padding, and other non-rigid materials that provide comfort and aesthetics. The soft goods may include seat covers (upholstery fabric or leather), foam padding and cushioning, headrests and armrest covers, seatbelts and harness padding, and stitching and decorative elements. The car seat shell assembly 2200 may include a movable rib/rim 2204 that is attached to the main housing 2202. The movable rib/rim 2206 is attached to the main housing 2202 at two connection regions 2208. The connection regions 2208 act as a cantilever connection and the movable rib/rim 2208 is configured to move in a first direction and an opposing second direction in a cantilever motion. The movable rib/rim 2204 includes two connections tabs 2206 that a configured to mate with two corresponding tab openings 2210 in the main housing 2202. The soft goods are configured to wrap around the movable rib/rim 2204 and fit between the movable rib/rim 2204 and the portion of the main housing 2202. FIG. 30D illustrates a view in which the movable rib/rim 2204 is fixed to the car seat shell main housing 2202.

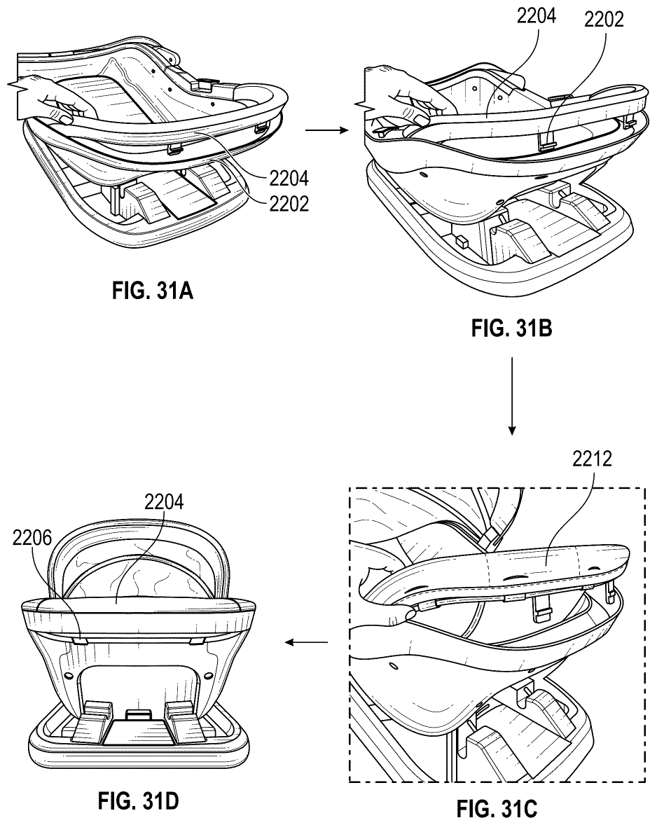

FIGS. 31A-31D illustrate a process for attaching soft goods to the car seat shell assembly 2200 according to an embodiment of the present disclosure. At the first step illustrated in FIG. 31A, the movable rib/rim 2204 is separated from the portion of the main housing 2202 by releasing the two tabs 2206. Thereafter, the moveable rib/rim 2204 may be lifted further to create enough space for the soft goods to wrap around, as illustrated in FIG. 31B. Then, the soft goods 2212 can be wrapped around the movable rib/rim 2204 as illustrated in FIG. 31C. Once the soft goods 2212 are wrapped around the movable rib/rim 2204, the movable rib/rim 2204 is lowered until the two table 2206 engage with the corresponding tab openings 2210. This secures the soft goods 2212 to the car seat shell assembly 2200, as illustrated in FIG. 31D. In order to remove/replace the soft goods 2212, a reverse process may be followed. In this manner the soft goods 2212 may be easily installed and removed from the car seat shell assembly 2200.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure.

While the present disclosure has been described with reference to a number of embodiments, it will be understood by those skilled in the art that the invention is not limited to such disclosed embodiments. Rather, the disclosure can be modified to incorporate any number of variations, alterations, substitutions, or equivalent arrangements not described herein, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description but is only limited by the scope of the appended claims.

What is claimed is:

1. A car seat and stroller system comprising:
a car seat shell;
a pair of connection brackets pivotably attached to the car seat shell;
a pair of front legs fixedly coupled to the car seat shell; and
a pair of back legs fixedly coupled to the car seat shell, wherein the car seat and stroller system is configured to be placed in an unfolded state and a folded state, wherein:
in the unfolded state, the pair of front legs are disposed toward a front end of the car seat and stroller system and the pair of back legs are disposed toward an opposing back end of the car seat and stroller system; and
in the folded state, the pair of front legs are disposed toward the back end of the car seat and stroller system and the pair of back legs are disposed toward the front end of the car seat and stroller system.

2. The car seat and stroller system of claim 1, further comprising a transverse member having a first end and an opposing second end, wherein the first end is connected to one of the pair of front legs and the second end is connected to one of the part of back legs.

3. The car seat and stroller system of claim 1, further comprising:
a first wheel connected to a front leg of the pair of front legs;
a second wheel connected to a back leg of the pair of back legs, wherein a first diameter of the first wheel is smaller than a second diameter of the second wheel.

4. The car seat and stroller system of claim 1, wherein in the folded state, the pair of back wheels and the pair of front wheels are disposed are along a ground plane.

5. The car seat and stroller system of claim 1, wherein each of the pair of connection brackets is rotatable around a first axis and configured to be placed in a first position and a second position, wherein in the second position, the pair of connection brackets are connectable to an anchor point in a vehicle.

6. The car seat and stroller system of claim 1, further comprising a first link member that is coupled to a second link member and wherein in the folded state, a first portion of the first link member and second portion of the second link member protrude behind the second wheel.

7. The car seat and stroller system of claim 1, further comprising a pair of front wheels coupled to the pair of front legs and wherein, in the folded state, each wheel of the pair of front wheels is located adjacent to and behind a respective connection bracket of the pair of connection brackets.

8. The car seat and stroller system of claim 1, further comprising a pair of front wheels coupled to the pair of front legs and a pair of back wheels coupled to the pair of back legs, and wherein in the folded state, the pair of front wheels are partially disposed in a recessed region of the car seat shell.

9. A car seat and stroller system comprising:
a first pair of legs;
a second pair of legs;
a car seat shell coupled to the first pair legs and the second pair of legs;
a pair of connection brackets pivotably attached to the car seat shell;
a first pair of wheels connected to the first pair of legs; and
a second pair of wheels connected to the second pair of legs;
wherein in an unfolded state of the car seat and stroller system, the first pair of legs are disposed toward a front end of the car seat and stroller system and the second pair of legs are disposed toward an opposing back end of the car seat and stroller system; and
in a folded state of the car seat and stroller system, the first pair of legs are disposed toward the back end of the car seat and stroller system and the second pair of legs are disposed toward the front end of the car seat and stroller system.

10. The car seat and stroller system of claim 9, wherein a first diameter of the first pair of wheels is smaller than a second diameter of the second pair of wheels.

11. The car seat and stroller system of claim 9, wherein each of the pair of connection brackets is rotatable around a first axis and configured to be placed in a first position and a second position, wherein in the second position, the pair of connection brackets are connectable to an anchor point in a vehicle.

12. The car seat and stroller system of claim 9, wherein in the folded state, the first pair of wheels are partially disposed in a recessed region of the car seat shell.

13. The car seat and stroller system of claim 9, further comprising: a first link member that is coupled to a second link member and wherein in the folded state, a first portion of the first link member and second portion of the second link member protrude behind the second pair of wheels.

14. The car seat and stroller system of claim 9, wherein to transition from the unfolded state to the folded state:
a first force is applied in a first direction to the first pair of legs; and
a second force is applied in a second direction to the second pair of legs, wherein the second direction is opposite to the first direction.

15. A car seat and stroller system comprising:
a car seat shell; and
a handle assembly connected to the car seat shell;
the handle assembly comprising:
a first member including a button;
a handle mode plate mechanically coupled to the button, the handle mode plate including a first pin;
a second member coupled to the first member; and
a hub assembly coupled to the second member, wherein the hub assembly is connected to the car seat shell, the hub assembly comprising:
a master plate having a slot and a plurality of recessed regions; and
a handle lock pin assembly coupled to the master plate and having a second pin and a third pin.

16. The car seat and stroller system of claim 15, further comprising:
a handle retainer plate coupled to the master plate; and
a pair of springs coupled to the handle retainer plate.

17. The car seat and stroller system of claim 15, wherein the handle mode plate is configured to mate with the handle lock pin assembly upon actuation of the button.

18. The car seat and stroller system of claim 15, wherein:
the first pin is traversable between a first set of recessed regions of the plurality of recessed regions;
the second pin is traversable within the slot; and
the third pin is traversable between a second of recessed regions of the plurality of recessed regions.

19. The car seat and stroller system of claim 18, wherein the first set of recessed regions are different from the second set of recessed regions.

20. The car seat and stroller system of claim 15, wherein the handle assembly is configured to rotate around a first axis in a first direction and an opposite second direction, and wherein when the handle assembly is rotated in the first direction:
the master plate is stationary; and
the first pin, the second pin, and third pin all rotate in the first direction.
